(19) United States
(12) Patent Application Publication
(10) Pub. No.: US 2012/0197967 A1
(43) Pub. Date: Aug. 2, 2012

(54) Socializing System, Framework and Methods thereof

(76) Inventor: Sivapathalingham Sivavakeesar, Wokingham (GB)

(21) Appl. No.: 13/015,348

(22) Filed: Jan. 27, 2011

(51) Int. Cl. G06F 15/16

(52) U.S. Cl. 709/203

(57) ABSTRACT

Internet has brought in different means of communication that go beyond the boundaries of conventional interaction/communication methods. Therefore, it should now be possible to communicate with total strangers securely without having to worry about privacies. This invention thus relates to a method/system/framework enabling an online directory creation for the purpose of anonymous communication/interaction among total strangers seamlessly and securely using one or plurality of communication modes/media/mechanism without compromising the privacies of the communication parties involved and without them having to know the exact contact details of each other. Also, modern communication technologies enable any social entity to have a numerous forms of contacts. A conventional business card cannot hold this growing number of contact details. The online directory allows any user to maintain a very dynamic virtual business card that can allow an owner to include/exclude different contact details dynamically at his/her discretion depending on the type of recipient(s).

### TECHNICAL FIELD

The invention relates to a method, system and framework for enabling anonymous communication/interactions among total strangers seamlessly and securely using one or plurality of communication modes/media/mechanism without compromising the privacy of the communication parties involved and without them having to know the exact contact details of each other.

### BACKGROUND

Business cards are normally used as a way to establish/maintain/keep personal and business links/contacts/relationship. With the wide spread availability of Internet and the different varieties of communication/interaction mechanisms it facilitates, and the advent of converged communication and computing system, any ordinary individual, business enterprise or an organisation (collectively referred to as an entity here onwards) gets an opportunity to have a plethora of contact details (i.e., points of contacts). These include the profile addresses of one or plurality of social networking sites (SNSs), instant messaging and presence services (IMPS), VoIP/V2IP services, online blogging, photo/video-sharing, genealogy, dating, gaming, diary and similar web-sites in addition to those details the conventional business card used to hold. As a result, a modern day business card needs to hold much information than the conventional business cards did. A conventional business card typically includes the giver's name and contact information such as street addresses, telephone number(s), fax number, email addresses and website.

Social networking in modern era has now become the most popular web activity, surpassing even email and many users have integrated these Social Networking Sites (SNSs) into their daily lives. With blurred boundaries, most online SNSs share some of the key features: i.e., allowing any individual to offer a “profile” through the site for others to peruse, with the intention of contacting or being contacted by others, to meet new friends or dates (e.g., Friendster, Orkut), find new jobs (e.g., LinkedIn), receive or provide recommendations (e.g., Tribe), and much more. Although the central tenets and key technological features of various SNSs' are fairly consistent, the cultures that emerge around them are varied. Hence, different social networking sites have different but unique features which justify their existences. For these reasons, different social networks will co-exist and the co-existence of numerous social networking sites means that each user or a business entity is likely to maintain numerous personal profile addresses with various SNSs. Social networking is nowadays used for meeting new partners and clients for business activities. The use of such social networking in an enterprise context presents the potential of having a major impact on the world of business and work. As a result, it is quite obvious that different profile addresses of a business enterprise or an individual person/user pertaining to a variety of SNSs need to find space in a modern day business card.

On a different note, with the ubiquitous availability of the Internet, VoIP/V2IP (e.g., Skype), Instant Messaging (IM) and similar modes of communication/interaction facilities are also on a constant rise. Hence, it is quite normal for an ordinary person/user or a business enterprise to maintain different accounts or profile addresses pertaining to these new modes of communication/interaction facilities. As a result, contact details pertaining to those new modes of communication/interaction facility should be part of a modern day business card of an individual/business.

Also, an individual or a business entity tends to have an own online web-album and/or audio/video album in a photo-sharing (e.g., picasa, flickr) and/or audio-/video-sharing web-sites respectively. Also, any entity might have a business/personal/group blog site(s). Further, an individual may have a profile in one or plurality of genealogy websites such as ancestry, family-tree, dating, gaming, recruitment, online gaming websites and the like. Accordingly, an individual or a business entity will have a profile address pertaining to these photo-/audio-/video-sharing, genealogy, dating, recruitment, online gaming and the like as well as blog web-sites and these details need to find appropriate space in the modern day business card of an individual or a business entity.

### DISCLOSURE OF THE INVENTION

With ever increasing contact details, a user/entity has to be given the flexibility to include/exclude certain contact details at his/its discretion from his/its business card very dynamically. In other words, the user/entity has to be given the chance to modify the contents (i.e., contact details) of his/its business card based on the type of his/its recipient(s). This should be possible prior to, at the time of or after business card exchange. These features enable any user/entity to maintain a single business card and exercise a minute control over who can see what contents of his/its business card. As of now this feature is not conveniently supported by any existing system, and one of the objectives of the present invention is to address this. In other words, as of now, there does not exist an online system that allows an entity to enrich its business card with the plethora of preferred contact details very dynamically at its discretion and distribute it electronically.

However, because of the physical size, the number of contact details a typical hardcopy version of a business card hold is limited. Further, because of the ubiquitous availability of web and the availability of cheap and sophisticated handheld mobile computing devices and the ever increasing contact details/information such as user/entity profiles maintained with a variety of SNSs, IMs, VoIP/V2IP system, dating/gaming, photo-/audio-/video sharing web-sites and the like, email, telephone numbers of landline/satellite/mobile phones, regular street addresses of home/business and the like a present day business card is expected to hold, it is desirable to pass around softcopy version of a business card. It can be performed in a peer-to-peer manner between two handheld devices for instance or via the Internet because of the emergence of Internet and smart handheld devices as the most effective and economical way for people to interact. Further, because of the vast amount of contact information an individual or a business entity has, it is very efficient and effective if a unique identifier pertaining to an individual or a business entity is exchanged or passed around and subsequently to download all the contact information from a centralised server/directory/repository/database using the exchanged unique identifiers. This attempt will in turn results in the creation of collaborative web-based online people/business directory/portal for more vibrant social networking experiences.

As perceived, the advent of Internet has brought in different means of communication that can go beyond the boundaries of conventional interaction/communication methods. As a result, it should be now possible to communicate with total strangers in a very secure manner without having to worry about privacy. For instance, there can be a situation where two entities want to communicate with each other without having to know the exact contact details of each other and without compromising privacy and security via a variety of communication/interaction mechanism/modes/media (e.g., telephone, Internet, email and regular postal mail). This has to be possible in the modern era—but this facility is not supported by many existing systems mainly because of security and privacy issues. Hence, another objective of this present invention is to enable this more securely via a plethora of communication modes/media/mechanisms provided by PSTN, PLMN, ISDN, VoIP, V2IP, IM, SNS or the like without compromising privacy/security of a user/entity.

Presently there lacks a single powerful web-portal or an SNS that people can use to accomplish various personal and/or business needs effectively and economically. Because of this, in order to accomplish a multitude of personal and business needs, people have to rely on a wide variety of websites. For instance, in the UK, in order to sell/purchase a used vehicle or a property, any one should rely namely on www.autotrader.co.uk or www.rightmove.co.uk respectively although there exists a multitude of websites in each category. More over, the seller/buyer has to make a moderate payment for using the services provided by these websites. There is, however, no single web-portal or an SNS for an individual to rely on economically for a multitude of such house-hold tasks that can enable anonymous communication/interaction between two or more strangers. Hence, one another objective of this patent is to rectify this by allowing individuals/businesses to advertise/sell/seek/buy services/products among themselves using the proposed online directory, which is enriched with enormous data to facilitate anonymous communication/interaction securely and seamlessly.

By achieving the above objective, the online directory is made to function as a Service Repository or an online portal. For this purpose, user-defined search criteria are mapped against the abundant information associated with each user of the online directory to provide customised views of the prospective user/viewer of the envisaged online Internet directory. Hence, another aspect of the present invention is to propose a method and system for letting users/businesses voluntarily enrich the said online directory with abundance of information in a collective and distributed way for the directory to function as a Service Repository.

The envisaged Service Repository enables automatic profile matching so that a service/product consumer/seeker can be made to be in contact with one or plurality of the most appropriate service/product providers. Given that the idea is to get households to get involved in business interaction with each other in a very economical way and hence there arises the need to protect households from possible dangers that may result from dealing with total strangers. This is where the anonymous communication/interaction facility being proposed by the present invention comes in.

When total strangers interact to accomplish a business transaction especially at a household level, their privacy settings may not allow their contact details to be visible to each other. But some kind of interaction or communication is needed among total strangers (e.g., between a service provider and a service consumer) before accomplishing a personal household or business task. Hence, as mentioned before one of the objectives of this present invention is to facilitate anonymous communication/interaction seamlessly that may inevitably arise among strangers without them having to necessarily know each other's contact information of any sort. The proposed system, methodology and a framework according to the preferred embodiment of this invention provides a platform that enables interactions between two sporadic strangers across various SNSs such as Twitter, Facebook, Skype, LinkedIn, MySpace, Hi5 and the like, and a wide variety of communication technologies (e.g., IM, SMS, Voice/Video communication via PSTN/ISDN/PLMN, VoIP networks, SNSs, even via regular posts) while hiding the underlying contact information and network complexities.

The novelty in here is that unlike other SNS, the communication/interaction is facilitated among strangers in real-time without them necessarily having to know any contact information. In other words, the type of secure, anonymous and seamless interaction/communication facility using a wide varieties of communication modes/media/mechanisms envisaged in the present invention is impossible with the existing SNSs as it will be described later. Some of the interaction/communication requires the parties to be online.

The envisioned online directory is hereinafter referred to as iDirectory in this document. The iDirectory details pertaining to an individual user is in fact a business card and such a business card is referred to as an iCard. The contact details found on an iCard are not visible to everybody and have fine granular privacy settings that allow any owner of a profile to control who can namely view the full or part of his/her profile or contact him/her anonymously.

### DESCRIPTION OF THE DRAWINGS

For a better understanding of the present invention, reference will be made to the following detailed description of the invention, which is to be read in association with the accompanying drawings, wherein:

FIG. 1A is an illustrative network environment where the embodiment of the present invention is said to work.

FIG. 1B illustrates the important components of a server application according to one embodiment of the present invention.

FIG. 2 illustrates one exemplary main profile window that can be used by an entity to create, activate and subsequently to maintain the mandatory profile with minute privacy settings according to one embodiment of the present invention.

FIG. 3 illustrates one exemplary window being used by an entity to exercise/perform minute privacy settings in terms of who can see what content according to one embodiment of the present invention.

FIG. 4 illustrates one exemplary window being used by an entity to exercise/perform minute privacy settings in terms of who can initiate an anonymous interaction/communication using what communication mode/medium/mechanism according to one embodiment of the present invention.

FIG. 5 shows one exemplary window being used to create the social sub-profile according to one embodiment of the present invention.

FIG. 6 illustrates the sequence of operations that will take place when one or plurality of profiles are created by the online profile creation mechanism according to one embodiment of the present invention.

FIG. 7 shows one exemplary window being used to create the dating sub-profile according to one embodiment of the present invention.

FIG. 8 illustrates the sequence of operations that will take place when virtual business cards are exchanged between two entities/users according to one embodiment of the present invention.

FIG. 9 exemplarily shows a list of entities/users (buddy-list) with which one entity/user has successfully exchanged its/his virtual business card allowing the owner to exercise itemised viewing settings according to one embodiment of the present invention.

FIG. 10 illustrates one exemplary window being used by an entity to exercise/perform minute itemised viewing settings against each entry of buddy-list according to one embodiment of the present invention.

FIG. 11 illustrates one exemplary login window required to sign/login in to the said centralized server through the local client application for the purpose of binding an entity/user to a client computing device being used according to an embodiment of the present invention

FIG. 12A exemplarily depicts the virtual business card belonging to a first entity as seen by a second entity when the privacy settings of a first entity are very lenient/relaxed or in case both entities are “friends” according to an embodiment of the present invention.

FIG. 12B exemplarily depicts the virtual business card belonging to a first entity as seen by a second entity when the privacy settings of a first entity are strict or in case both entities are “non-friends” according to an embodiment of the present invention.

FIG. 13 illustrates the sequence of operations that will take place as part of anonymous interaction/communication attempt between two strangers according to one embodiment of the present invention.

FIG. 13A illustrates the further sequence of operations that will take place when the anonymous interaction/communication involves using a PSTN/PLMN/ISDN network as the communication mode/medium/mechanism according to one embodiment of the present invention.

FIG. 13B illustrates the further sequence of operations that will take place when the anonymous interaction/communication involves using the Internet network as the communication mode/medium/mechanism according to one embodiment of the present invention.

FIG. 14A illustrates the further sequence of operations that will take place when the anonymous interaction/communication involves using the email as the communication mode/medium/mechanism according to one embodiment of the present invention.

FIG. 14B illustrates the further sequence of operations that will take place when the anonymous interaction/communication involves using the regular mail as the communication mode/medium/mechanism according to one embodiment of the present invention

FIG. 15 shows one exemplary window being used to create the online gaming sub-profile according to one embodiment of the present invention.

FIG. 16 shows one exemplary window for the customised online calendar/diary sub-profile creation of an embodiment of the present invention.

FIG. 17 illustrates one exemplary search window to enable customised view of the online directory entries according to an embodiment of the present invention.

FIG. 18A illustrates one exemplary resulting list view of the main profile search using the occupation as the sole filtering/search criterion according to an embodiment of the present invention.

FIG. 18B illustrates one exemplary resulting list view of the online gaming sub-profile search according to an embodiment of the present invention.

### DESCRIPTION OF SPECIFIC EMBODIMENTS

The present invention will now be described in a more elaborative manner hereinafter with reference to the accompanying figures, which form a part hereof, and which show, by way of illustration, specific exemplary embodiments by which the invention may be practised. This invention may, however, be embodied in many different forms and should not be construed as limited to the embodiments set forth herein; rather, these embodiments are provided so that this disclosure will be thorough and complete, and will fully convey the scope of the invention to those skilled in the art.

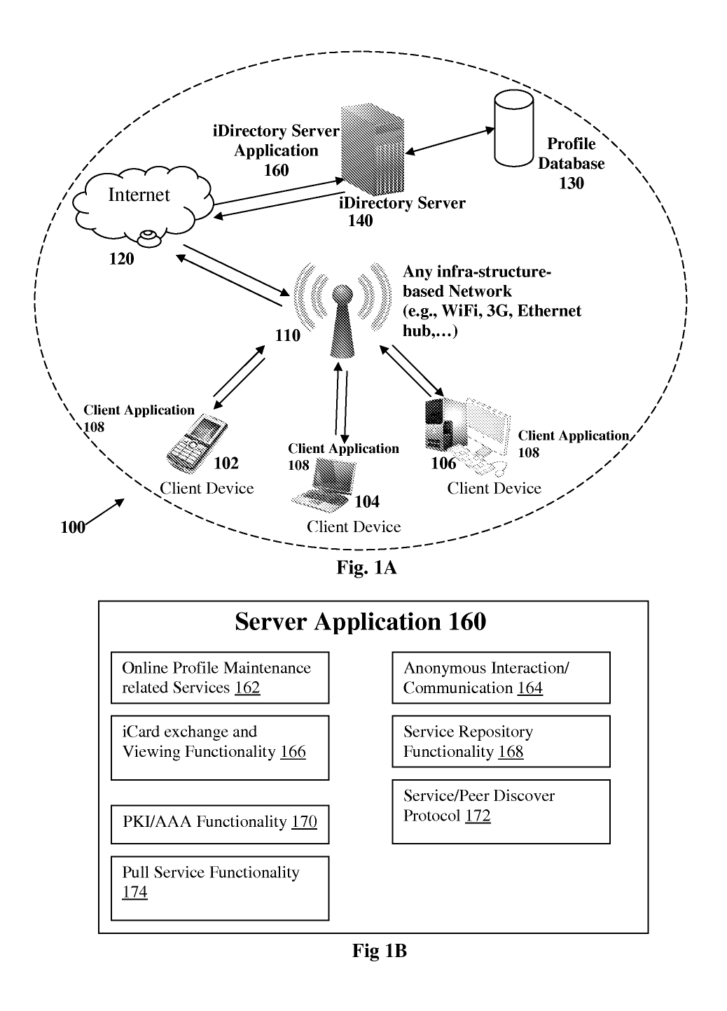

FIG. 1A illustrates an exemplary environment in which the present invention may operate. However, it has to be noted that all of these components may not be required to practice the invention, and changes in terms of the arrangement and type of the components may be made without deviating from the scope of this invention.

The system/framework 100 which allows the creation and management of an online directory or web-portal (termed iDirectory) that is enriched with abundance of information put together in a very concise and a distributed way by individuals in order to create/maintain and exchange a modern day virtual business card comprising a plethora of contact details of all kinds and to enable vibrant social networking experiences is proposed with an objective to accomplish a multitude of day-to-day household and business tasks effectively and economically. According to the preferred embodiment of the present invention, the proposed system/framework 100 comprises an infra-structure-based network 110 which is connected to the Internet cloud 120, a variety of handheld devices such as mobile/smart phones, netbooks, tablets, e-readers or a personal digital assistant (PDA) 102, nomadic clients 104 and fixed clients 106 comprising namely of laptops, personal computer and/or the like, and a server 140 connected to a variety of databases. The profile database 130 holds a plurality of virtual business cards and associated information pertaining to an individual/group/business (referred to as an entity here onwards).

In the illustration of the primary sections of the system 100 of the present embodiment, through a handheld client device 102 (e.g., mobile phone, smart-phone, personal digital assistant (PDA), netbook or similar device), laptop 104 or a personal computer 106, any entity can access the centralised iDirectory server 140 via the Internet 120 and perform operations such as maintaining a profile and a virtual business card in the profile database 130, exchanging and viewing other entities' virtual business cards, looking for specific information/profiles with an appropriate search/filtering on the profile database 180, and/or anonymously interacting or communicating with another registered entity even when the contact details are not known to each other. Each client device 102, 104 and 106 runs purpose-built software called a client application 108.

The infra-structure-based network 110 and the Internet cloud 120 provides a ubiquitous communication and computing network enabling the connectivity between the client application 108 running on any client device 102/104/106 and the server application 160 running on the centralised directory server 140. The infra-structure-based network 110 can be any base station belonging to any cellular network, WiFi, WiMAX, Ethernet hub or similar fixed/wireless/mobile networks. Networks such as 110 and 120 are configured to couple one computing device to another facilitating communications/interactions between them. A client device 102, 104 or 106 is capable of receiving and sending messages over a network such as 110 and 120 to and from another computing device such as the central directory server 140, each other and like.

Each of the client devices 102, 104 and 106 runs a client application 108 and communicates via the network 110 and 120 with the server 140. The server 140 runs its own server application 160 having multiple functionalities as shown in FIG. 1A and communicates with a number of online databases namely the profile database 130 containing user profiles. The client application 108 and server application 160 interacts with each other namely for the purpose of online profile creation/activation/maintenance (i.e., edit/delete/deactivate), exchange/viewing of a virtual business card, and anonymous interaction/communication as it will be explained later.

The server application 160 comprises a multitude of functionalities namely online profile creation/maintenance (e.g., editing/deleting) functionality 162 whereby the server application 160 liaises with the profile database 130 in order to assign unique profile identifiers (termed Profile-IDs) on a successful main profile creation and activation by any entity/user for the first time, virtual business card exchange and viewing functionality 166, pull service functionality 174 in case the server application 160 needs to accept various queries having one or plurality of search criteria/filters pertaining to directory entries and to return results satisfying the queries, proxy server functionality 164 in order to enable anonymous interaction/communication among the registered users who happen to be total strangers to each other and hence do not know each other's exact contact information, PKI/AAA-related functionalities 170 for mutual authentication and AAA purposes.

According to one preferred embodiment of the present invention, the server application 160 includes such extra functionalities as service repository functionality 168 enabling different entities to use the profile database to hold the products/services each entity provide/seek and peer/service discovery protocol functionality 172 in order to periodically identify the correct peer users or the services/products they provide. According to one another preferred embodiment, the service repository functionality 168 maintains a tree-based registry in order to logically group services/products by category with the help of each entity and to locate the required services/products within each category with minimal search time. Accordingly, a tree has a number of levels that represent service/product classification. With this, as we move down the tree from the root to the leaves, services/products become more specific. This tree-based approach enables each node to maintain the known services/products in a systematic fashion, and hence helps to minimize the latency involved in the service discovery process. For example, a printer service/product can be identified by the following logical path name: “<path> RootService: Hardware_Service/Product: Print_Service/Product: LaserPrint</path>,” under which one can easily identify the preferred printer of one's choice depending on its attributes (e.g., color, 300 dpi, 35 ppm). These extra functionalities will be elaborated in the subsequent pages. According to one preferred embodiment of the present invention, the centralised profile database 130 is indexed by the said unique profile identifiers.

The server 140 is generally a combination of hardware and software, the software including an operating system which is of different flavours of Windows, Linux, Android and the like. Also, the server application 160 or client application 108 can be written according to a number of different known programming languages, technologies, and/or a combination thereof. The server application 160 takes an additional responsibility to run centralised service/peer discovery protocol proactively (driven mainly by timeouts) in order to perform perfect profile matching (e.g., between a service provider and a service consumer). On the other hand, another additional functionality of the server application 160 also supports pull services as well (driven mainly by events) whereby whenever a user/entity looks for a specific product, service, or one or plurality of users/entities satisfying a certain filtering criteria, the server application 160 will accept requests, subsequently coordinates with one or plurality of databases namely 130 and return the correct results to requesting user/entity. In this case, the server application 160 accepts search criteria from a client application 108, runs a search (i.e., peer/service discovery protocol) and returns the search results back to the client application 108 in question. The said server application 160 constantly runs a timer, and whenever a time-out occurs it executes any service/peer discovery protocol.

Accordingly, the system/framework 100 as shown in FIG. 1A comprise namely a profile database 130 to hold a plurality of virtual business cards and associated information pertaining to an entity, an online profile creation mechanism, a centralised server 140 connected to the said profile database 130 for operating the said profile database 130 and running a server application 140, one or plurality of entities (e.g., users, companies, groups, organisations and the like) each using a client computing device 102/104/106 running a client application 108 each; and, an availability of ubiquitous communication and computing network 110/120 enabling the connectivity between said client application 108 running on any client device 102/104/106 and the said server application 160 running on the said centralised server 140.

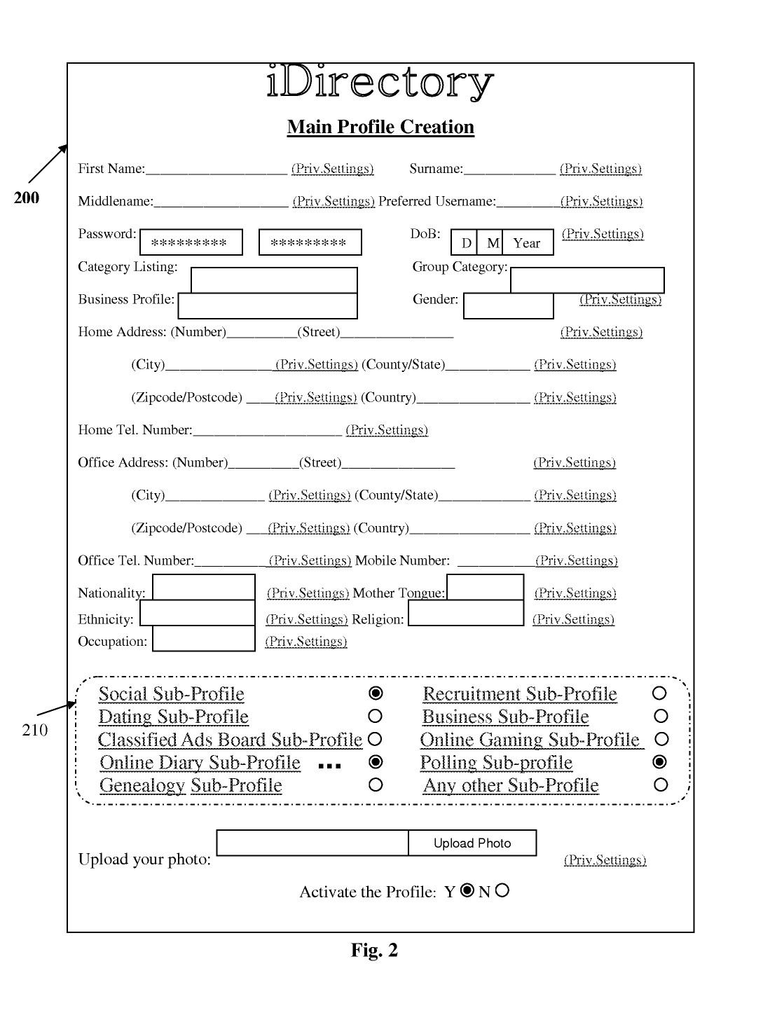

FIG. 2 illustrates one exemplary main profile window that can be used by an entity to create, activate and subsequently to maintain the mandatory profile according to one embodiment of the present invention.

According to one preferred embodiment, the profile creation consists of two important parts. The first part of the profile creation is mandatory whereas the second part is the optional sub-profile creations as depicted in FIG. 2—with the former, an online iDirectory can be created in a very distributed way at a global level; on the other hand, with the latter as shown in 210 of FIG. 2, users can enrich their main profile with abundance of information put together in a very concise and a distributed way in order to accomplish day-to-day household and business chores/needs.

The profile creation is one of the main aspects for the envisaged iDirectory to work. The objective of the profile settings is to uniquely identify/bind/verify a particular individual/group/business. When creating profiles, an entity has to correctly fill in an exemplified form 200 as shown in FIG. 2. In the profile window 200, any entity needs to enter the first name, surname, middle name (if any), preferred user name, preferred password twice, home/office address and the corresponding telephone numbers, email address, date-of-birth, mobile telephone number, main nationality, and other personal information as shown in FIG. 2. Some of these fields are not relevant when a profile is created for a business entity or a group, and they will be left blank automatically by the client application 108 depending on whether a profile is created for an individual, group or a business entity.

Drop-down lists can be provided to ease the task of an entity to fill in 200. The profile creator acting on behalf of an individual, a group or a business entity has to choose the most appropriate category that applies to the profile. This is again in the form of a drop-down list and it has at least four values for the profile creator to indicate whether the profile is for an individual, an organisation, a group or a business entity.

If the profile is for a group/organisation, the profile creator has to specify the actual descriptive type of the group (i.e., group category in 200)—for instance, whether it is a religious group, nurses group, IT group and so on. The profile creator has the luxury to choose the appropriate one from the drop-down list. On the other hand, in case the profile creation is meant for a business entity, its business category, product/service, industry type (for example, plumbing) need to be indicated in an additional sub-profile windows (not shown)—again this field makes use of a drop down list. Products/services are systematically categorised for this purpose—this part is outside the scope of the present invention.

Depending on the profile category type, unwanted profile fields can be disabled at the time of a profile creation. For instance, in case a profile is for an individual person's use, the group category and business category fields of 200 can be disabled.

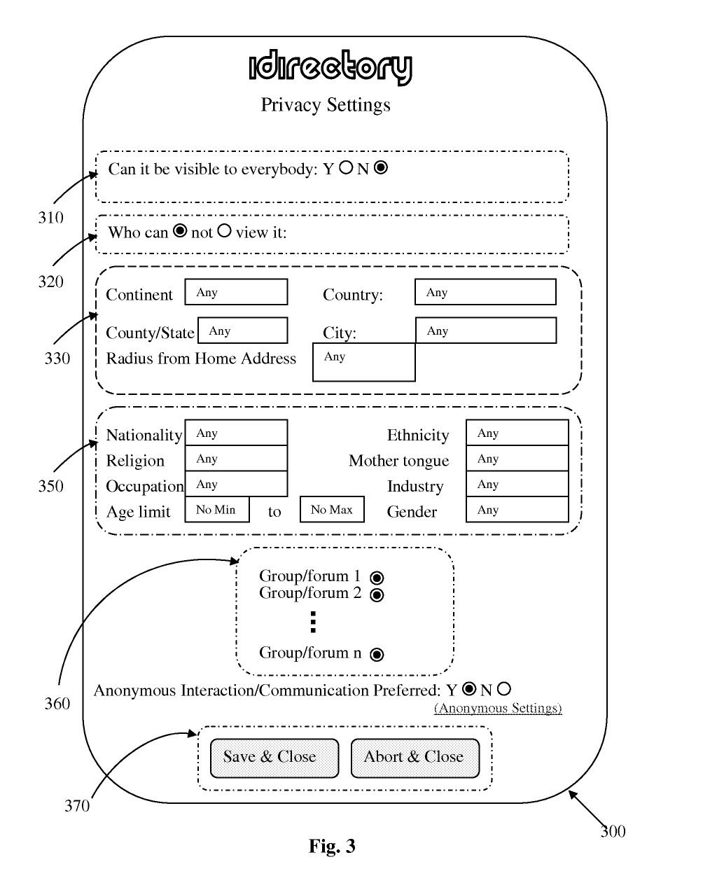

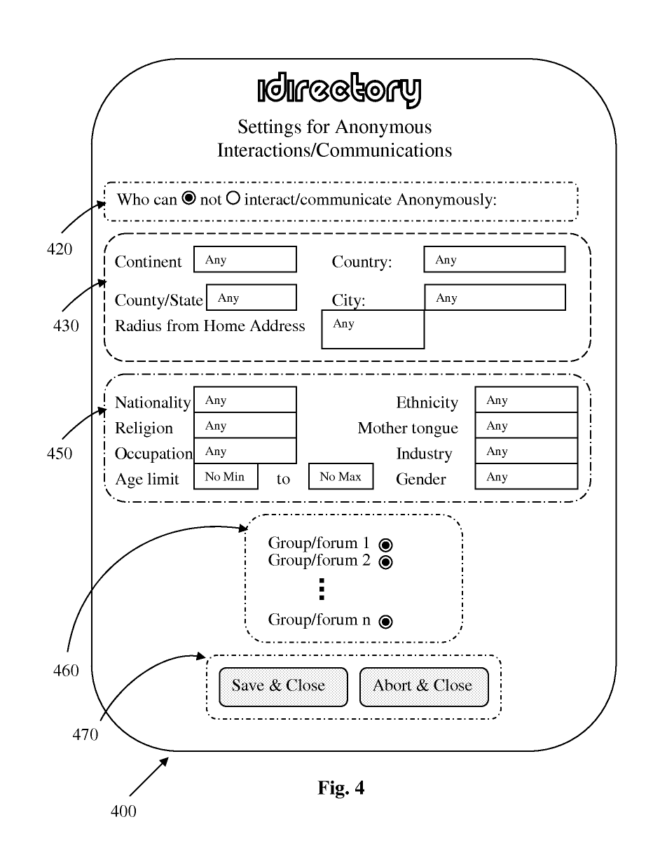

It is preferred that the drop-down lists' contents can be added/augmented by the profile creator, in case the original list has not contained the most appropriate entry. When entering each detail 200, an individual/group/organisation/business is given a chance to exercise minute control over who can view what information—this is in the form of privacy settings. For this purpose each entry/field of 200 is accompanied by privacy settings hyperlink/tab/button and when being pressed, it will open up an exemplarily window as shown in FIG. 3.

Once such personal information has been entered, an entity has to optionally complete the section as identified by 210 (i.e., a plurality of sub-profiles) of FIG. 2. This includes at least social sub-profile which is intended to consist of an entity-specific plurality of unique profile addresses pertaining to various SNSs/IMs/VoIP/V2IP services, Recruitment sub-profile, Dating sub-profile, Business sub-profile, classified ads board sub-profile, online gaming sub-profile, user-specific polling sub-profile, user-specific online diary sub-profile and any other sub-profile the creator or the owner of a profile wants to create. In this respect, the sub-profile creation is at the user's discretion in terms of the choice and this sub-profile list is not exhaustive. New sub-profiles can be added depending on future trends, technological developments and user preferences.

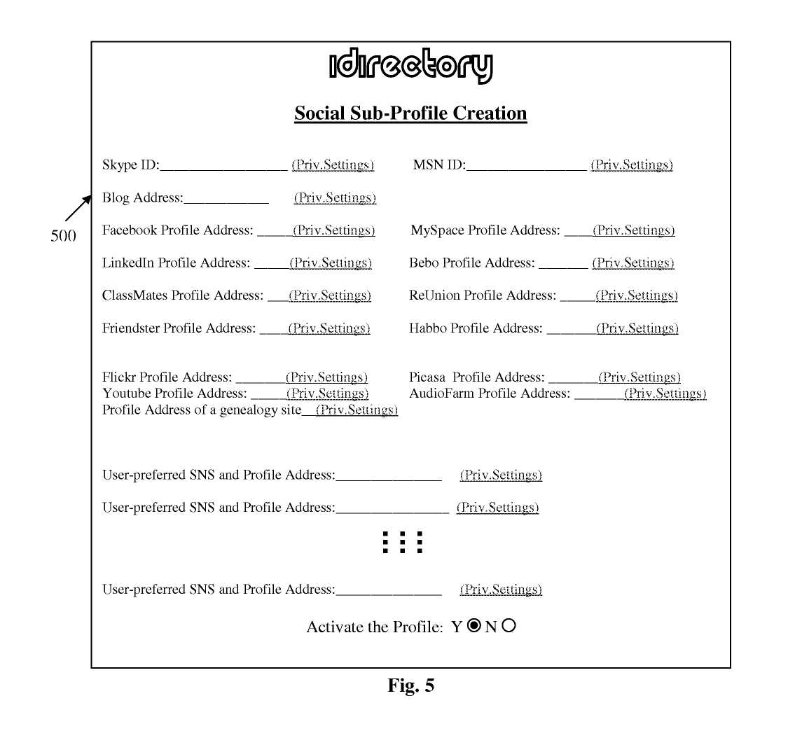

In order to complete different sub-profiles, the profile creator has to click the correct hyperlink of 210 of FIG. 2. For instance, when a user wants to create a social sub-profile, a new window 500 of FIG. 5 will appear and this is quite useful to enrich one entity's virtual business card with plethora of contact information. Similarly in order to create/activate/maintain different sub-profiles as shown by 210, different windows/forms can be used. Once created, each sub-profile and the main profile needs activation by the user. When the main mandatory profile is activated, the client application 108 being used to create the profile will contact the server application 160 while passing the profile specific information. The server application will generate a unique profile identifier termed Profile-ID and store the profile data in 130 while using the Profile-Id as the index. The system as shown by 100 will then use Profile-IDs to identify a given user/entity. According to one embodiment of the present invention, assigning a Profile-ID to an entity requires some kind of formal verification of an entity using some third party services. For instance, verification is possible using a credit/debit and similar smartcard. For this purpose, an entity/user is required to provide such credit/debit card details as part of the main profile creation/activation and charged a nominal fee. This way an entity can be formally verified—this is desirable to provide secure anonymous interaction/communication between two or more strangers as intended in this present invention. The main profile window 200 can be augmented to include fields for an entity to give such formal verification details.

FIG. 3 illustrates one exemplary window being used by an entity to exercise/perform minute privacy settings in terms of who can see what content of a virtual business card according to one embodiment of the present invention. Each entry/field of 200 has such privacy settings and when clicked an exemplarily window as shown in 300 will appear allowing an entity/user to specify whether the associated entry/field of 200 can be made viewable or not in 310 by any other entity/user. If viewing is allowed, further restrictions are possible based on demography, geography, political views, gender, occupation, age range and the like of a viewer. Such stepwise restrictions are possible with the facilities as exemplarily shown by 320, 330, 350 and 360 of FIG. 3. In case a particular entry/field of 200 has any thing to do with a communication mode/medium/mechanism (e.g., mobile phone number, Skype ID, postal address, email address, Instant Messaging ID and the like), the owner (say, first entity) of a profile 200 has further an option to specify whether anonymous interaction/communication has to be associated with a particular entry/field. When an associated hyperlink is clicked, an exemplary window as shown by 400 will show up in order to further control as to who can use the given communication mode/medium/mechanism to contact a first entity anonymously without having to know the exact contact details. Such restrictions are again based on demography, geography, political views, gender, occupation, age range and the like as shown by 420, 430, 450, and 460 of FIG. 4. Once the privacy settings are made in 300 and 400, the owner is required to save & close the settings by clicking respectively 370 and 470. If these are not clicked or when user deliberately clicks the abort & close button, the privacy settings will not be stored and have no effect for future use.

Social sub-profile is created with the exemplified profile form as shown in 500 of FIG. 5. In the case of social sub-profile creation, the user/entity can specify at its discretion the profile addresses of one or plurality of SNSs (e.g., Facebook, LinkedIn, Twitter, MySpace, Hi5, and the like), Instant Messaging and Presence Services (IMPS) such as MSN messenger, Google Talk, ICQ and the like, VoIP/V2IP services (e.g., Skype), photo-/audio-/video-sharing web-sites (Picasa, Flickr and the like), online blogging, genealogy, dating, gaming, diary and similar web-sites as shown in 500 of FIG. 5. According to one preferred embodiment, if anonymous interaction/communication is preferred the user/entity has to locally configure the client application 108 running on a client device 102/104/106 with the login information of respective SNSs/IMPS/VoIP/V2IP services. This login information pertaining to other SNSs/IMPS/VoIP/V2IP are locally stored and hence such details are not available for the server application 160. However, the user's profile information centrally stored in the profile database 130 includes information like what type of SNSs/IMPS/VoIP/V2IP a given user has included in his/her profile.

Again different entries/fields of 500 can be subject to itemised privacy settings individually. This will control what type of contact information is made visible in the virtual business card—again this depends on the viewer's characteristics.

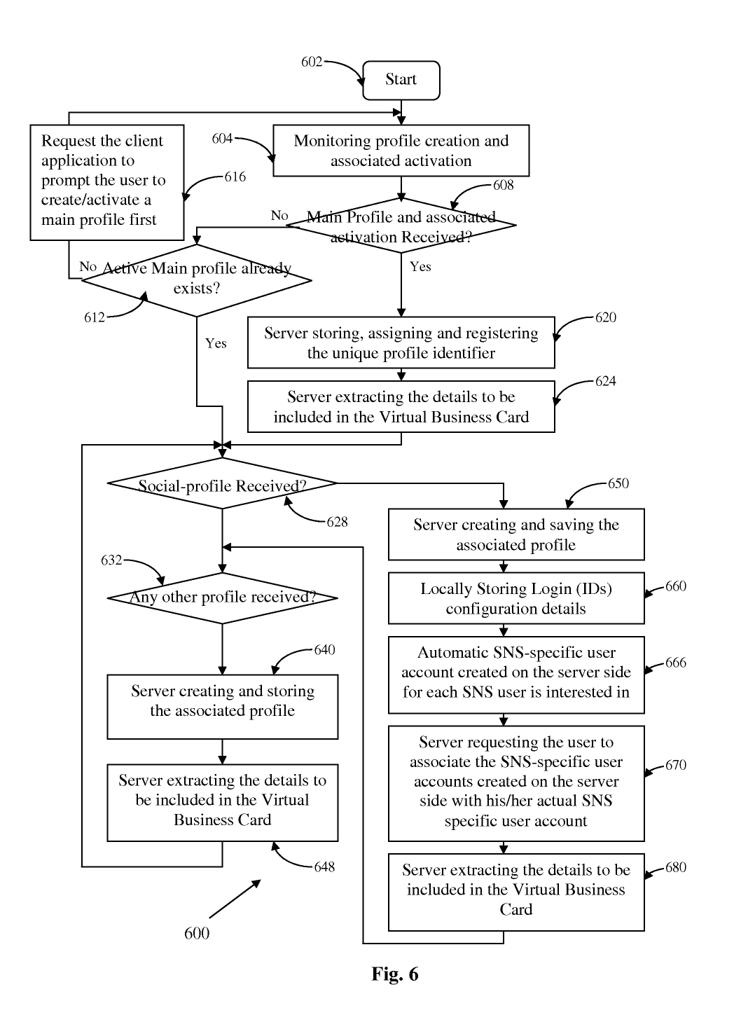

The flowchart of FIG. 6 illustrates the sequence of operations that will take place when one or plurality of profiles are created by the online profile creation mechanism according to one embodiment of the present invention. This is described from the perspective of a server 140 that runs a server application 160. However, the client application 108 running on 102/104/106 is the one that interacts with a user/entity at the time of profile creation. The client application 108 enables any entity/user to create/activate/edit/maintain/delete a mandatory main profile (as exemplarily shown by 200) which expects entity-specific important (e.g., personal) details for the server 140 to uniquely identify/verify/bind the entity/user concerned and a social sub-profile (as exemplarily shown by 500) containing plethora of contact details pertaining to a varieties of communication/interaction mode/media/mechanisms. Details collected as part of this can consist namely the first/middle/last names, date of birth, sex, business/personal addresses, photograph, land/mobile phone numbers and other optional details such as one or plurality of vehicle registration numbers, nationality, religion, ethnicity, mother-tongue, occupation and the like on the said profile database for the server to uniquely identify a user and subsequently a social sub-profile enlisting a multitude of profile addresses of various SNSs/IMPS/VoIP/V2IP and other websites pertaining to a given entity and other contact details using a client device 102/104/106.

After a main profile creation, when an entity/user activates the profile, the client application 108 will establish necessary connections with 140 and to register the created main profile and the social sub-profile with the said profile database 130 using the said unique profile identifier as the index by liaising with the server application 160 via the said ubiquitous communication and computing network 110/120. As mentioned before, one of the functionalities of 160 is to liaise with 108 to create/maintain an active profile of an entity in 130. Accordingly, after a continuous monitoring as shown by the processing step 604, in the decision-making step 608 the server application 160 will check whether it has received any request in relation to main profile creation and associated activation from the client application 108 running on any client device 102/104/106. If it has, the server application 160 assigns a unique profile identifier (i.e., Profile-ID) to each entity and stores the profile information in the profile database 130 and indexing the entry using the Profile-ID as shown in step 620. With this step, a given entity/user is registered with the system 100. Also, the server application 160 will extract the necessary details that can be included in a virtual business card namely names, addresses, telephone numbers and the like in 624 at the discretion of the entity concerned based on the privacy settings as explained in relation to FIG. 3.

On the other hand, in case different profile information is received by 160, in the decision-making stage 612, the server application 160 will check whether an active profile will exist for an entity. If not, the server application will request the client application to prompt the user to create/maintain an active main profile first as shown by 616. In contrast, if the main profile already exists and a different sub-profile is received pertaining to a given entity/user, the server application 160 will further check in 628 whether the profile information received from a registered entity is social sub-profile. If it is the case, the server application 160 will first create, save, and associate the received social sub-profile with the main profile in 130—this is shown by the processing step 650. Once this operation has successfully taken place, 160 will request the client application 108 to get each entity to configure the local client application 108 with the entity-specific login IDs pertaining to preferred communication/interaction modes/media/mechanisms namely SNS/IMPS/VoIP/V2IP services (e.g., Skype, MSN messenger, Google Talk, ICQ, Twitter, Yahoo, MySpace, Facebook and the like) being included in the said social sub-profile when prompted. This will enable the client application 108 of each entity to keep records of the profile addresses along with the given entity's login IDs pertaining to the user accounts of the said preferred communication/interaction modes/media/mechanisms locally at the time of social sub-profile creation—this is shown by 660.

Once operation as indicated by 660 have successfully taken place, the server application 160 will automatically create and store user accounts pertaining to preferred communication/interaction modes/media/mechanisms namely SNS/IMPS/VoIP/V2IP services (e.g., Skype, MSN messenger, Google Talk, ICQ, Twitter, Yahoo, MySpace, Facebook and the like) depending on a given entity's preferred SNS/IMPS/VoIP/V2IP services where those user accounts correspond to every first entity, passing those details on to the given entity's client application 108 and requesting the given entity to associate those automatically created user accounts with its own corresponding user accounts. These processing steps 666 and 670 are needed only when a given entity is interested in anonymous interaction/communication facility as envisaged by the present invention. For instance, Skype account being created automatically by 160 on the server side for every entity A has to be associated with the Skype account being maintained by a given entity A. The server application 160 will then extract the necessary details that can be included in a virtual business card namely the profile addresses pertaining to preferred communication/interaction modes/media/mechanisms namely SNS/IMPS/VoIP/V2IP and like services in 680 based on the privacy settings as explained in relation to FIG. 3.

If, on the other hand, the sub-profile information being received at the decision-making stage 628 is not in connection with social sub-profile, it will be further checked in 632 the exact type of sub-profile being received. For instance, it can be in relation to dating, recruitment, online gaming and the like as shown by 210 of FIG. 2. Depending on the exact type, the server application 160 will create, save, and associate the received sub-profile with the main profile in 130 as shown by the processing step 640. Subsequently in 648, the server application 160 will then extract the necessary details that can be included in a virtual business card namely profile addresses pertaining to preferred dating, online gaming, recruitment, genealogy, online calendar/diary, classified like ebay and the like websites in 648 based on the privacy settings as explained in relation to FIG. 3. Please note that each sub-profile of an entity is linked to its main profile and indexed by a Profile-ID.

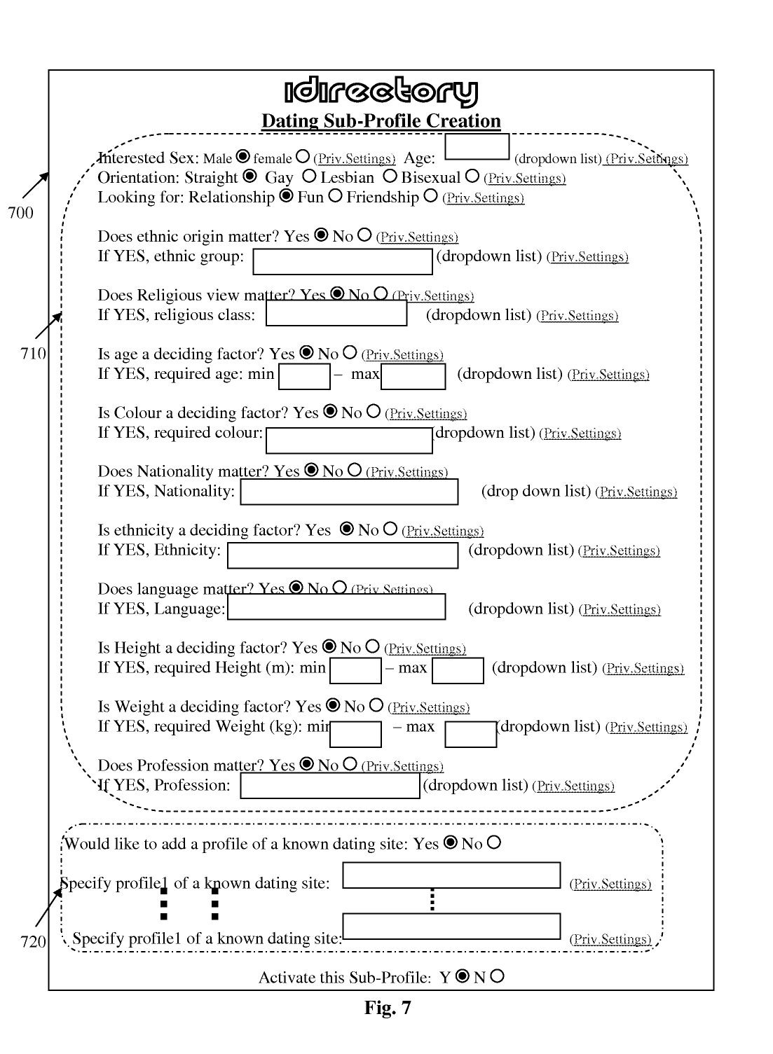

FIG. 7 shows one exemplary window being used to create the dating sub-profile according to one embodiment of the present invention. This is very similar to social sub-profile creation with an exception that an entity is allowed to create a very tailor-made dating sub-profile with an exemplarily form/window shown by 710 and/or to include the profile addresses of one or plurality of existing dating websites such as match.com in 720. Similar approach is applied to the creation and maintenance of other sub-profiles such as online blogging, genealogy, online gaming, recruitment, genealogy, online calendar/diary, classified like ebay. On receiving this information, the server application 160 will make the online directory function as a service repository or web-portal as it will be explained later.

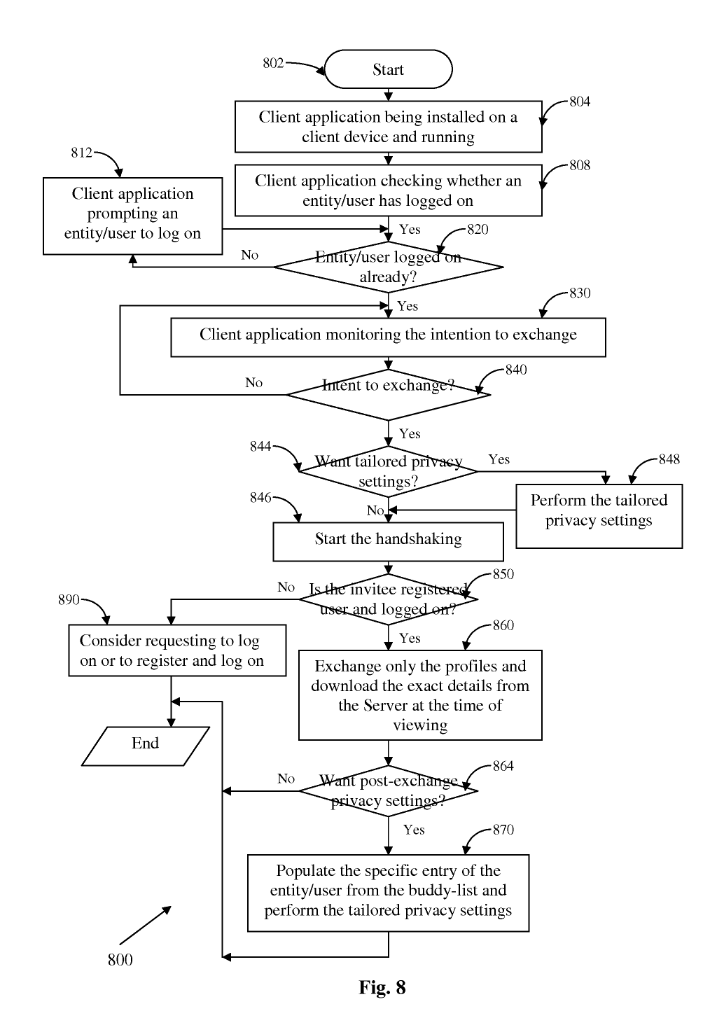

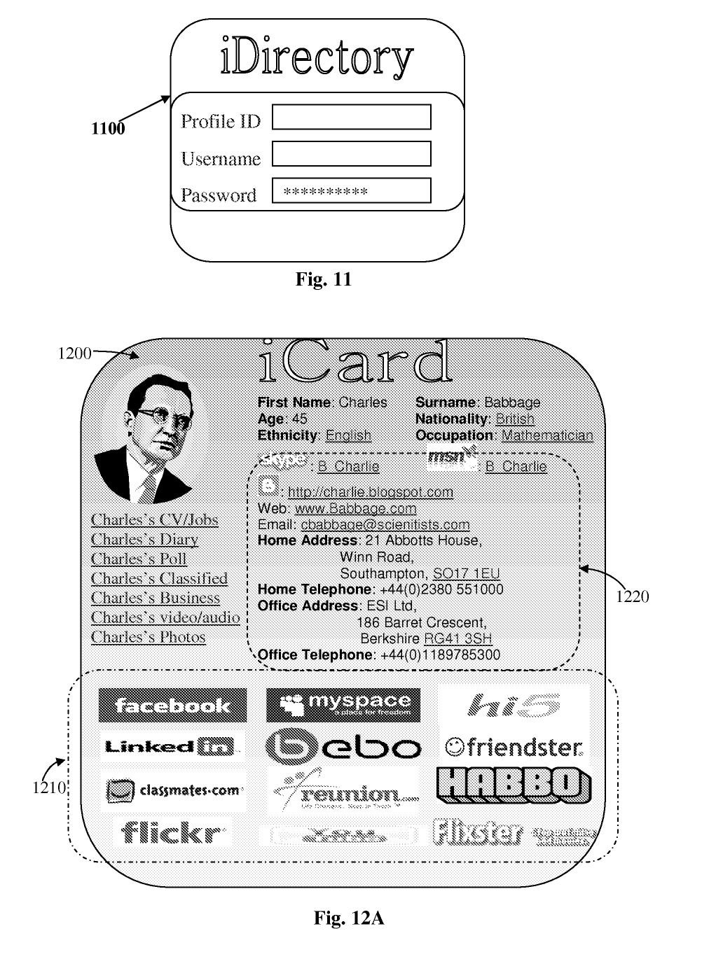

The flowchart 800 of FIG. 8 illustrates the sequence of operations that will take place when virtual business cards are exchanged between a first registered entity and a second entity according to one embodiment of the present invention. This exchange takes place electronically via the client computing devices 102/104/106 in a peer-to-peer manner and for this purpose the involved client computing device 102/104/106 has to run the client application 108 as shown by the processing step 804 of 800. Once installed, the client application 108 of 102/104/106 runs a virtual business card exchange procedure. According to one embodiment, each client application 108 running on 102/104/106 will first check in 808/820 whether an entity/user has already signed in or logged on to a centralised server 140 through 108 using a login window 1100 as exemplarily shown in FIG. 11—this process is needed mainly because it binds the profile of a given entity/user to the client computing device 102/104/106 being used. The flowchart 800 describes a scenario where a first registered entity initiates an exchange with a second entity.

If a first registered entity/user has not signed in or logged on, the client application 108 will prompt the user/entity in 812 to sign in or log on using an exemplary login window shown in FIG. 11. If, on the other hand, a first registered user/entity has logged on or signed in, the client application 108 of first entity will constantly capture whether a first entity intents to exchange the virtual business card from any user input (e.g., voice, keypad/mouse/touchpad and the like)—the associated operations involved at this stage are shown by 830.

In case there is an intention for an exchange as learnt at the decision-making stage 840, the client application will further check at 844 whether a first registered entity would like to perform some privacy settings that can allow/prevent a second entity to/from view/viewing a given entry/field or piece of information appearing on the virtual business card of a first registered entity. It is a matter of indicating yes/no to each entry/field of a virtual business card before being forwarded to a second entity. If this is the case, a first registered entity is allowed to perform the privacy setting that is tailor made to a second entity as shown by 848. Once it is performed, the client application 108 of a first registered entity will initiate the initial handshaking with the client application of a second entity as indicated by 846. If a second entity is registered and logged on or signed in as checked at the decision-making stage 850, it will be notified of a possible exchange (possibly with a help of a pop-up window, a voice alert or the like). With certain user settings, exchange can directly take place and after a business card exchange only will the notification appear on the client device 102/104/106 of first/second entities as indicated by the processing step 860.

According to one another embodiment of the present invention, after an alert/notification, a second entity may respond positively/negatively to the exchange attempt taken by a first entity. In this case after a positive notification, a first entity can exchange a virtual business card with a second entity. This exchange can take place either online or offline. According to one another preferred embodiment, at the time of virtual business card exchange as shown by the processing step 860 only the unique profile identifiers (i.e., Profile-IDs) of first/second entities are exchanged in a peer-to-peer manner and then the actual virtual business card is downloaded by a client application 108 from the centralised database 130. For this purpose 108 interacts with the server application 160.

The initial handshaking that takes place between two client applications 108 will help a client application of a first entity figure out whether a second entity has registered and signed in and also whether its client computing device 102/104/106 has a running client application installed. According to one preferred embodiment, each client application 108 will send a greeting message initially (e.g., HELLO) when an entity would like to exchange. If a client application of a second entity receives the greeting message from a first entity, it will always respond irrespective of whether a second entity is online or offline. In case no response is received in response to an initial greeting message from a given second entity, the first entity can consider inviting a second entity to register first with the centralised server 140 and exchange a virtual business card later as indicated by the processing step 890.

Under normal circumstances, the virtual business card exchange can take place via the Internet. However, in case a client computing device 102 happens to be a mobile computing device such as a mobile/smart-phone, personal digital assistant and the like, a virtual business card exchange can take place via an ad-hoc network formed on-demand between mobile client devices 102/104 being used by a first and second entities. This ad-hoc network may use NFC, WiFi, Bluetooth, ZigBee, IR or any other short-range radio technology. For this purpose each mobile computing device 102/104 should be equipped with one or plurality of appropriate transceivers.

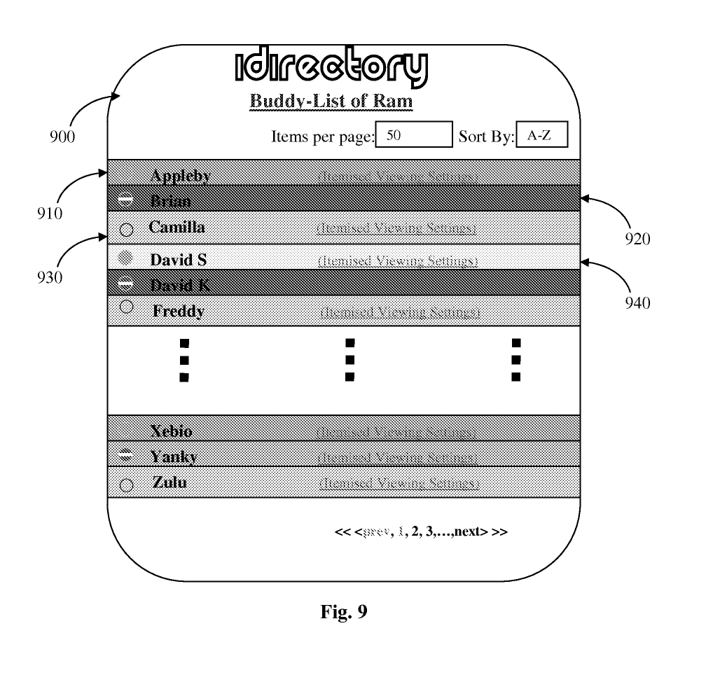

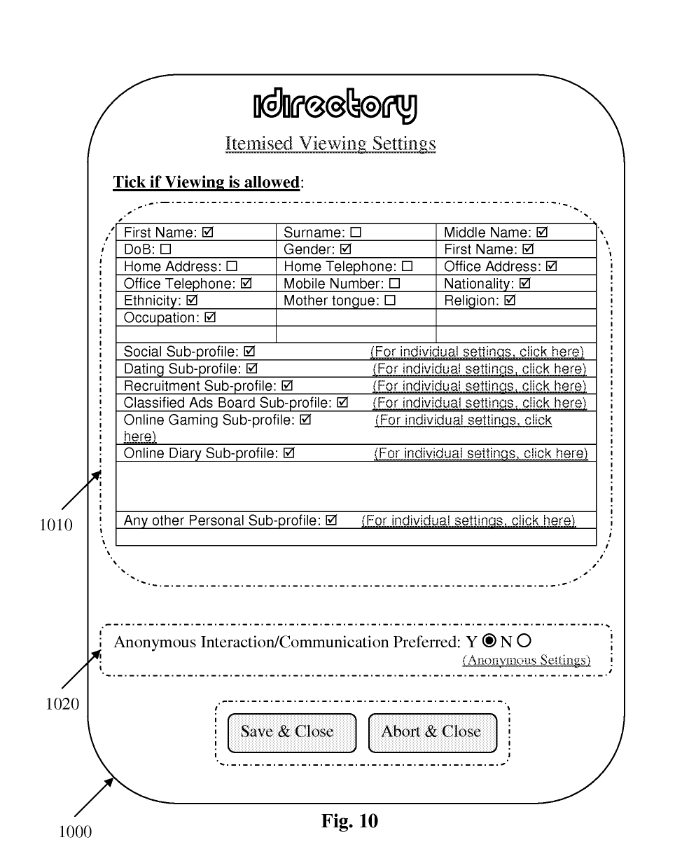

Once the respective virtual business cards are exchanged, an entity A becomes “buddy” of an entity B and vice-versa. The term “buddy” is very analogous to “friends”. Each registered entity can maintain a buddy-list comprising of other entities to which the former has successfully exchanged its virtual business card as shown in FIG. 9.

As indicated by the decision-making stage 864, if post-exchange tailor made privacy settings are preferred by either entity, it can be performed. For this purpose, an entity/user has to populate its buddy-list to perform tailor-made privacy settings against a given entry/buddy as it will be explained in relation to FIG. 9. This is shown by the processing step 870.

FIG. 9 exemplarily shows a list of entities/users (buddy-list) with which one entity/user has successfully exchanged its/his virtual business card allowing the owner to exercise itemised viewing settings according to one embodiment of the present invention. This buddy-list indicates generic online status corresponding to each entry/entity. Suppose a second user/entity appearing in the buddy-list of a first user/entity maintains active accounts with Skype, Facebook and MSN and a second entity/user has signed in its/his/her Skype account, the client application 108 of second entity can learn this and notify the server application 160 so that the client application 108 of first entity/user will show up the online status of second entity/user as being online. In other words, if a second entity/user has signed in at least one of the active accounts it maintain with SNS/IMPS/VoIP/V2IP services (e.g., Skype, MSN messenger, Google Talk, ICQ, Twitter, Yahoo, MySpace, Facebook and the like), it online status on the buddy-list belonging to first entity/user is same as that of the account that it has signed in. In case a second entity has signed in more than one account, the online status of the buddy-list will take that of an account that is being in use by a second entity at any moment. The online status can be online, busy, offline, away and the like.

The buddy-list may have a number of columns to further describe the entries in terms of demography, geography, political views, gender, occupation, age range and the like. This will allow the entries of a buddy-list to be sorted based on any of these extra details provided—for instance, sorting of a buddy-list can be possible based on age. The question of whether this extra information pertaining to a buddy-list member can be visible to the buddy-list owner depends on the privacy settings of the former. Further, the number of entries that should appear in each page of a buddy-list can be user-settable. Further, multiple page view of a buddy-list is also possible.

According to one preferred embodiment, the buddy-list will allow the owner to exercise minute tailor-made privacy settings being applied to an individual list member. For this purpose, each entry of a buddy-list is associated with a hyperlink called itemised viewing settings. When clicked, an exemplary window as shown by 1000 of FIG. 10 will appear enabling the owner of a buddy-list to exercise minute privacy settings against each entry. In 1010, the owner of a buddy-list can allow/prevent each entity appearing on the buddy-list to/from view/viewing a given piece of information like name, Date-of-birth (DoB) and the like. Using 1020, the owner of a buddy-list can specify whether any form of anonymous interaction/communication can be entertained/allowed from a given buddy-list member. Once settings are made, for them to take effect, they need to be saved.

FIG. 11 illustrates one exemplary login window being required by any registered entity to sign/login in to the said centralized server 140 through the local client application 108 for the purpose of binding an entity/user to a client computing device 102/104/108 being used according to an embodiment of the present invention. According to one preferred embodiment, in order to login or sign in, an entity has to know its unique Profile-ID being assigned by 140, username and password. The unique Profile-ID can be preferably emailed to the user on a successful main profile creation/activation as explained in relation with FIG. 2. The username and password are those set by an entity at the time of main profile creation/activation as shown in 200. Signing in with 140 is necessary in case a registered user would like to create one or plurality of sub-profiles, to make modifications to the existing profiles, and to deactivate/activate or even to delete the main or different sub-profiles.

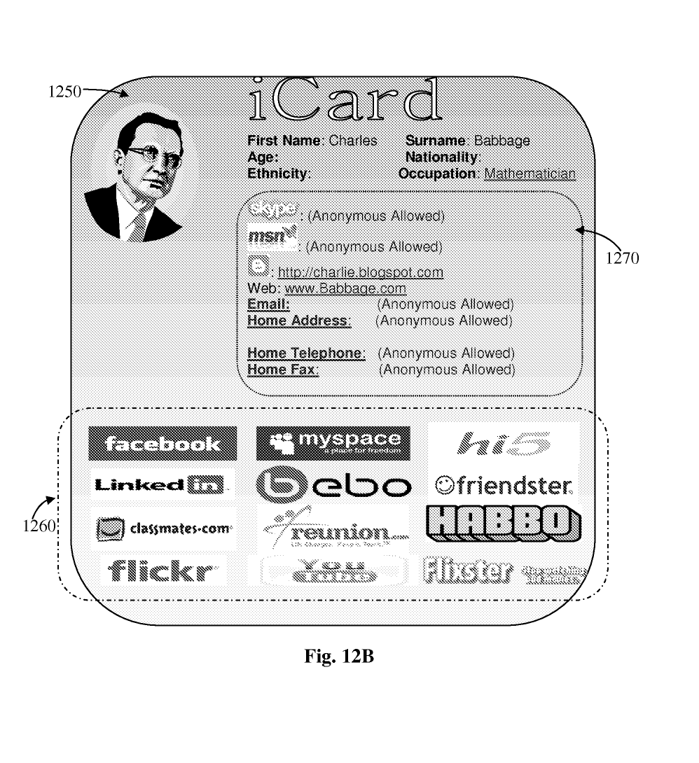

FIG. 12A exemplarily depicts the detailed view of a virtual business card belonging to a first entity as seen by a second entity when the privacy settings of a first entity are very lenient/relaxed or in case both entities are “friends” or “buddies” according to an embodiment of the present invention. In this case, every possible (contact) information being included in a virtual business card by a first entity can be viewed by a given second entity—as explained before, this minute control is still exercised by the owner of a virtual business card (i.e., in this case it is a first entity). The virtual business card includes name, and addresses, telephone numbers, mobile numbers, email addresses and web sites pertaining to home/office. It can also include profile addresses of one or plurality of SNSs (e.g., Facebook, LinkedIn, Twitter, MySpace, Hi5, and the like). It can further include profile addresses of Instant Messaging and Presence Service (IMPS) such as MSN messenger, Google Talk, ICQ and the like and VoIP/V2IP services (e.g., Skype). Profile addresses of photo-/audio-/video-sharing web-sites such as Picasa, Flickr and the like can be also part of a virtual business card. This is also true for the profile addresses of dating, recruitment, classified advertisement, recruitment, business, online multiplayer gaming, online polling, online diary/schedule/calendar and the like. One or plurality of these contact details can be given by an entity at its discretion as part of a main profile and/or social sub-profile creation as explained before.

As long as the privacy settings of the owner allows, the virtual business card of a first entity as seen by a second entity will also show the communication status of each interaction/communication mode/medium/mechanism such as SNS/IMPS/VoIP/V2IP service and the like being included in the virtual business card. This information is gathered by the server application 160 from the client application 108 of first entity (both push and pull approach to gather such information is possible) and passed on to the client application 108 of second entity in order to show this type of itemised communication status in the virtual business card.

As mentioned before, the virtual business card allows its owner to have the flexibility in terms of the ability to include/exclude any number of contact details at his/her discretion depending on the type of recipient and to exercise a minute control over who can see what type of contact details dynamically.

If a second entity is already a “friend” of first entity as far as a given SNS/IMPS/VoIP/V2IP service (e.g., Skype, MSN messenger, Google Talk, ICQ, Twitter, Yahoo, MySpace, Facebook and the like) is concerned, then with a click of a corresponding profile address, first and second entities can interact in the chosen communication mode/medium/mechanism (e.g., SNS/IMPS/VoIP/V2IP service). On the other hand, if both entities are not “friends” from the perspective of a given SNS/IMPS/VoIP/V2IP service chosen, then anonymous interaction/communication via the chosen communication mode/medium/mechanism is possible only if the privacy settings of the entity to which the said anonymous interaction/communication is targeted allow.

FIG. 12B exemplarily depicts the limited view of a virtual business card belonging to a first entity as seen by a second entity when the privacy settings of a first entity are strict or in case both entities are “non-friends” according to an embodiment of the present invention. In this case, if a first entity does not want a particular contact information (e.g., Skype ID) to be visible to a second entity—but at the same time can entertain an anonymous interaction/communication from a second entity via a given communication mode/medium/mechanism (i.e., Skype), a corresponding icon will appear (i.e., Skype icon). In this case, when a second entity clicks the preferred icon (i.e., Skype icon) an anonymous interaction/communication can be initiated between first and second entities via a given communication mode/medium/mechanism (i.e., Skype).

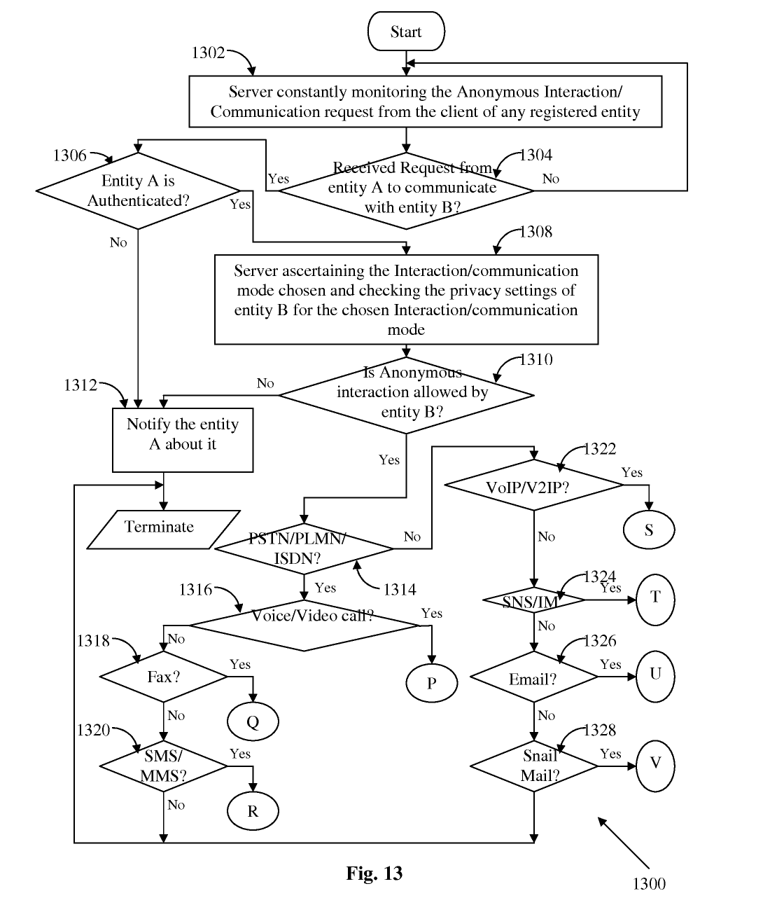

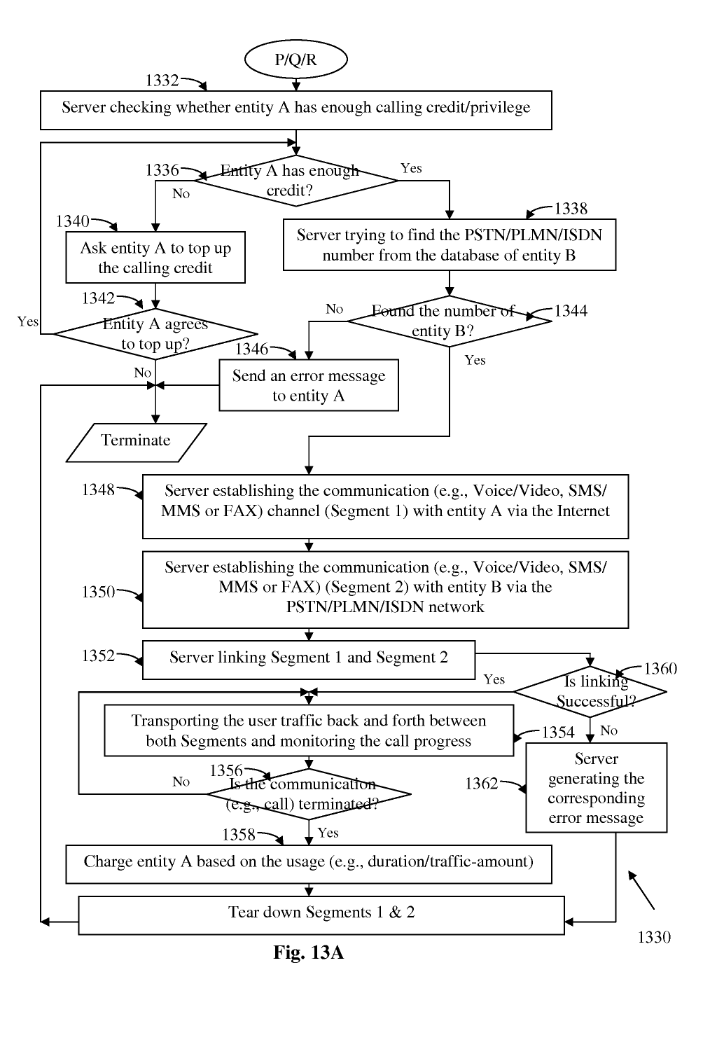

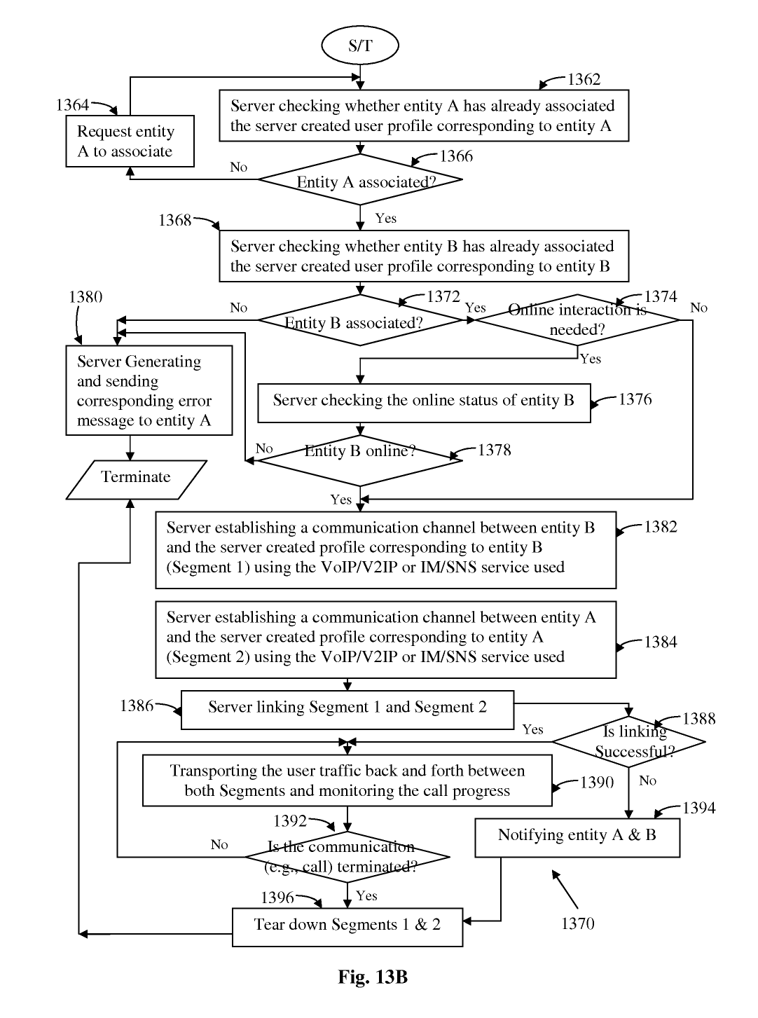

The flowchart 1300 of FIG. 13 illustrates the initial sequence of operations that will take place as a priory when any form of anonymous interaction/communication via a variety of communication modes/media/mechanisms (namely PSTN/PLMN/ISDN, email, regular postal mail, or SNS/IMPS/VoIP/V2IP service) is attempted/made between two strangers according to one embodiment of the present invention. The system/framework 100 allows anonymously interaction/communication between two or more entities that are total strangers to each other only when those entities involved already maintains active profiles in the said centralised directory 130. This initial sequence of operations that is needed prior to any anonymous interaction/communication attempt is an authentication/security procedure.

As shown in FIG. 13, the authentication/security procedure starts at 1302 and in the processing step 1304, the server application 160 constantly monitors for any anonymous interaction/communication request originating from any client application 108 of a registered entity. In case the client application 108 of a first entity informs a first entity's (i.e. entity A) intent to the said server application 160, the condition of decision-making stage 1304 will be satisfied and hence the authentication/security procedure proceeds to step 1306 where the said server application 160 will first subject a first entity to an authentication process. On being successfully authenticated, the said server application 160 will ascertain the interaction/communication mode/medium/mechanism (namely PSTN/PLMN/ISDN, email, regular postal mail, or SNS/IMPS/VoIP/V2IP service) chosen by a first entity for the anonymous interaction/communication and check the privacy settings of a second entity (entity B) for the chosen interaction/communication mode/medium/mechanism. The said server application 160 will proceed to the next stage only if the anonymous interaction/communication via the chosen mode/medium/mechanism is allowed by a second entity as stipulated in its privacy settings—this is checked at 1310; otherwise the server application 160 will terminate the anonymous communication attempt by a first entity and notify it with an appropriate error message as indicated by 1312. This is also the case when the authentication of first entity fails as checked in 1306.

If, on the other hand, the privacy settings of a second entity allow the said anonymous interaction/communication by a first entity via the chosen communication mode/medium/mechanism, the server application 160 will make further decisions based on the chosen communication mode/medium/mechanism. As checked in the decision-making stage 1314, in case the chosen communication mode/medium/mechanism is/uses PSTN/PLMN/ISDN, the server application 160 will run a circuit-switched procedure 1330. If, on the other hand, the chosen communication mode/medium/mechanism is/uses Internet as checked in 1322, the server application 160 will run the Internet procedure 1370. If, on the other hand, the chosen communication mode/medium/mechanism is/uses electronic messaging/mailing as checked in 1326, the server application 160 will run the email procedure 1400. If, on the other hand, the chosen communication mode/medium/mechanism is/uses regular postal mailing as checked in 1328, the server application 160 will run the snail mail procedure 1450.

As indicated by 1318 and 1320, further classifications are possible even within the circuit-switched procedure 1330 depending on whether the anonymous interaction/communication uses voice/video call, fax or SMS/MMS. However, all of these sub-divisions are still handled by the circuit-switched procedure 1330. This also true for the Internet procedure 1370 where further sub-divisions are possible based on whether the anonymous interaction/communication uses VoIP/V2IP or SNS/IMPS service as indicated by 1322 and 1324. However, all of these sub-divisions are still handled by the Internet procedure 1370.

As mentioned before, registered entities are identified by their respective unique profile identifiers (Profile-IDs) by the said system 100 and for such a seamless and anonymous communication/interaction to take place the second entity has to be registered and maintains an active profile with the said system 100 and the privacy settings of the second entity should allow such an anonymous communication/interaction from a stranger.

The flowchart 1330 of FIG. 13A illustrates the further sequence of operations that will take place when the anonymous interaction/communication involves using a PSTN/PLMN/ISDN network as the communication mode/medium/mechanism according to one embodiment of the present invention. This flowchart 1330 is a continuation of 1300 as the control flows from 1300 via the control points P, Q and R. The flowchart 1330 illustrates the operations of the circuit-switched procedure.

Once the circuit-switched procedure 1330 has started, the server application 160 will first check from the profile database 130 whether a first registered entity (i.e., entity A) has enough calling credit/privilege to interact/communicate with another entity via a PSTN/PLMN/ISDN network—this is indicated by 1332 and 1336. If a first registered entity does not have enough calling credit/privilege, the server application 160 will request it to top up its calling credit before it can proceed further as shown by the processing step 1340; otherwise the server application 160 will terminate the circuit-switched procedure 1330.

If, on the other hand, a first registered entity has enough calling credit/privilege, the server application 160 will try to get the PSTN/PLMN/ISDN number of a second registered entity (i.e., entity B) with which a first entity tries to interact/communicate anonymously from its profile information being stored in the said profile database 130 as indicated by the processing step 1338. If a second entity's PSTN/PLMN/ISDN number is not found as checked in the decision-making stage of 1344 due to the fact a second registered entity has not included its PSTN/PLMN/ISDN number in its profile, the server application 160 will send a corresponding error message to a first entity and terminate the said circuit-switched procedure as indicated by 1346.

If, on the other hand, it turns out from the processing step 1344 that the PSTN/PLMN/ISDN number of a second registered entity is found by 160, the said server application 160 will establish in the processing step 1348 the necessary communication channel (Segment 1) with a first registered entity via the Internet that can support the required service (e.g., Voice/Video, SMS/MMS or FAX) with the appropriate quality of service (QoS). If the operation associated with 1348 is successful, the server application 160 will then proceed to establishing the necessary communication channel (Segment 2) with a second registered entity via the PSTN/PLMN/ISDN network with the adequate capacity depending on the service (e.g., Voice/Video, SMS/MMS or FAX) that need to be supported—this is indicated by 1350. If the operation associated with 1350 is successful, the server application 160 will subsequently link/map Segment 1 and Segment 2 in 1352.

If the linking/mapping operation is successful as checked in 1360, the server application 160 will start transporting user traffic back and forth between both Segments 1 and 2 and monitoring the progress of the communication/interaction session in 1354. If, on the other hand, the linking is unsuccessful, the server application 160 will tear down Segments 1 & 2, generate a corresponding error message and notify the parties involved in 1362.

In case the anonymous communication/interaction session is terminated as checked in 1356, the server application 160 will tear down Segments 1 and 2, terminate the anonymous session and charge a first registered entity based on usage/time (i.e., time duration of the whole session or type/amount of traffic generated/received as part of the anonymous interaction/communication) as indicated in 1358.

The flowchart 1370 of FIG. 13B illustrates the further sequence of operations that will take place when the anonymous interaction/communication involves using the Internet network as the communication mode/medium/mechanism according to one embodiment of the present invention. This flowchart 1370 is a continuation of 1300 as the control flows from 1300 via the control points S and T. The flowchart 1370 illustrates the operations of the Internet procedure.

Once the Internet procedure 1370 has started, the server application 160 will first check in 1362 whether a first registered entity (i.e., entity A) has already associated the automatically created user account with its own corresponding user accounts pertaining to the communication/interaction mode/medium/mechanism (e.g., VoIP/V2IP/IM/SNS such as Skype, MSN messenger, Google Talk, ICQ, SIP, Twitter, Yahoo, MySpace, Facebook and the like) chosen for the anonymous interaction/communication. The outcome of 1362 is checked in 1366 and if not associated already, the server application 160 requesting a first registered entity to associate the user accounts—this is indicated in 1364.

If, on the other hand, user accounts of first registered entity are already associated, the server application 160 will further check whether a second registered entity has already associated the automatically created user account with its own corresponding user accounts pertaining to the communication/interaction mode/medium/mechanism chosen by first registered entity for the anonymous interaction/communication. This is performed in 1368 and the outcome is analysed in 1372. If not associated, the server application 160 will generate a corresponding error message, notify first registered entity about it and terminate the Internet procedure 1370—this set of operations is performed in 1380.

If, on the other hand, a second registered entity has already associated the server created account with its own account, the server application 160 will check whether the anonymous interaction/communication requires the parties involved to be online in 1374. If it turns out from 1374 that an online interactive participation is required by both entities, the server application 160 will check the online status of second registered entity corresponding to the anonymous interaction/communication mode/medium/mechanism (e.g, VoIP/V2IP/IM/SNS and the like) chosen in 1376. The outcome of 1376 is analysed in 1378.

If it turns out from 1378 that a second entity is online, the server application 160 will proceed to the next stage (i.e., to 1382); otherwise it will generate a corresponding error message, notify a first registered entity about it as indicated in 1380 and terminate the said Internet procedure.

If being online, the server application 160 will establish a communication channel in 1382 between a second registered entity and the server created profile corresponding to a second registered entity (Segment 1) using the VoIP/V2IP/IM/SNS service used. If the operation of 1382 is successful, the server application 160 will further establish a communication channel in 1384 between a first registered entity and the server created profile corresponding to a first registered entity (Segment 2) using the VoIP/V2IP/IM/SNS service used.

If the operation of 1384 is successful, the server application 160 will subsequently link/map Segment 1 and Segment 2 in 1386. If the linking/mapping is successful as checked in 1388, the server application 160 will start transporting user traffic back and forth between both Segments 1 and 2 and monitoring the progress of the communication/interaction session in 1390. On the other hand, if the linking is unsuccessful, the said server application will tear down Segments 1 & 2, generate a corresponding error message and notify the parties involved as indicated in 1394 and 1396.

In case the anonymous communication/interaction session is terminated as checked in 1392, the said server application will tear down Segments 1 and 2 in 1396 and terminate the anonymous session.

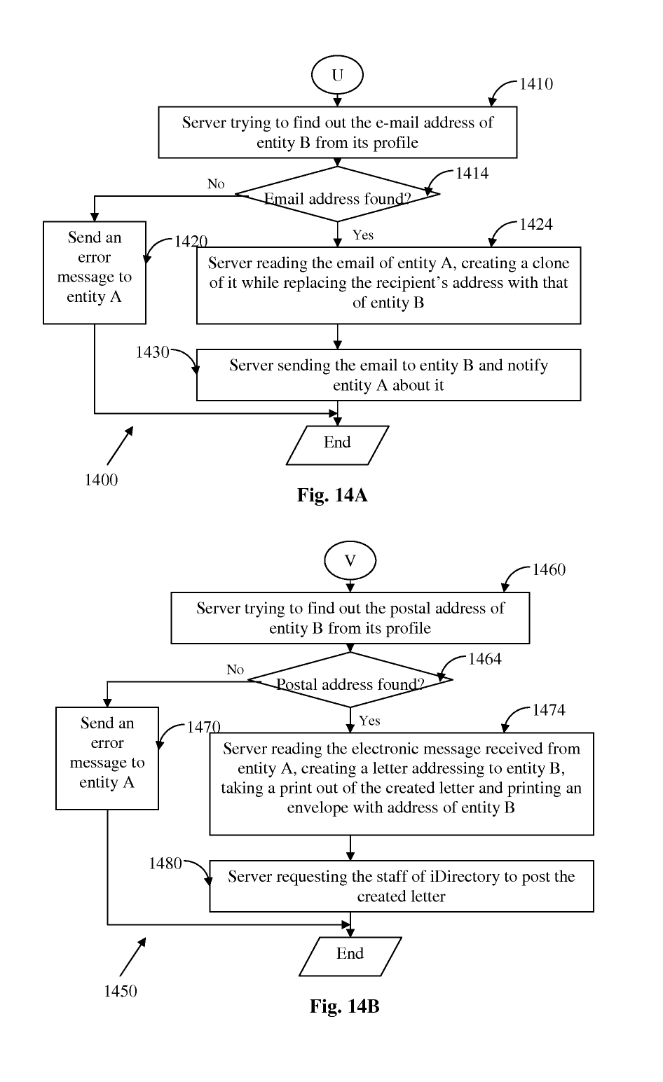

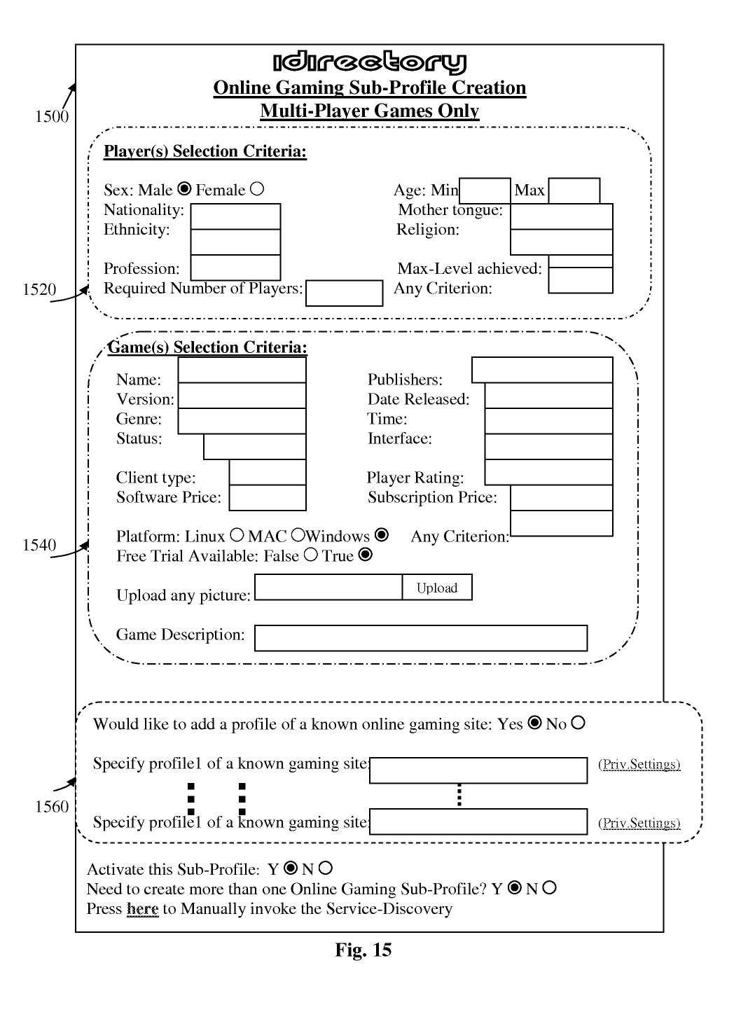

The flowchart 1400 of FIG. 14A illustrates the further sequence of operations that will take place when the anonymous interaction/communication involves using the email as the communication mode/medium/mechanism according to one embodiment of the present invention. This flowchart 1400 is a continuation of 1300 as the control flows from 1300 via the control points U. The flowchart 1400 illustrates the operations of the email procedure.

Once the email procedure 1400 has started, as indicated in 1410 the server application 160 will first try to get the email address of a second registered entity (i.e., entity B) from its profile being stored in the said profile database 130. The result of 1410 is analysed in 1414. In case a second registered entity does not include its email address in its profile as checked in 1414, the server application 160 will send a corresponding error message to a first entity (i.e., entity A) in 1420 and terminate the email procedure 1400. If, on the other hand, the server application 160 has obtained the email address of a second registered entity, the server application 160 will read the email from a first registered entity, create a clone of it while replacing the recipient's address with that of a second registered entity as shown by 1424. The server application 160 will subsequently send the email to a second registered entity and notify a first registered entity about it—as indicated in 1430.

The flowchart 1450 of FIG. 14B illustrates the further sequence of operations that will take place when the anonymous interaction/communication involves using the regular postal mail as the communication mode/medium/mechanism according to one embodiment of the present invention. This flowchart 1450 is a continuation of 1300 as the control flows from 1300 via the control points V. The flowchart 1450 illustrates the operations of the snail mail procedure.

Once the snail mail procedure 1450 has started, as indicated in 1460 the server application 160 will first try to get the regular postal address of a second registered entity (i.e., entity B) from its profile being stored in the said profile database 130. The result of 1460 is analysed in 1464. In case a second registered entity does not include its regular postal address in its profile as checked in 1464, the server application 160 will send a corresponding error message to a first entity (i.e., entity A) in 1470 and terminate the snail mail procedure 1450.

If, on the other hand, the server application 160 has obtained the regular postal address of a second registered entity, the server application 160 will read the electronic message received from a first registered entity, create a letter addressing to a second registered entity, take a print out of the created letter and print an envelope with the postal address of a second registered entity. This set of operations is performed in 1474. The server application 160 will subsequently request the staff of iDirectory in 1480 to post the created letter.

In addition to holding virtual business card related information, the server 140 and the associated databases (namely the profile database 130) can function as a service repository or web-portal keeping plethora of entity-specific information/profiles pertaining to dating, online gaming, recruitment, classified ads, online diary/calendar and the like. Hence, the server 140, its server application 160 and the associated database 130 can additionally provide online directory service with a view to let possible strangers interact/communicate anonymously.

For instance, one objective is to get the central profile database 130 to keep one or more up-to-date gaming profiles of each online gamer and also to get the server application 160 to run periodically a centralised service discovery protocol and the associated functionality 172 for the purpose of automatically helping each player proactively find one or more appropriate peer players while meeting the selection/filtering criteria as set out in the online gaming sub-profiles of each user. A user can create and activate an online gaming sub-profile using the exemplified form/window 1500 shown in FIG. 15.

In the case of multiplayer online interactive gaming that requires two or more players, the gaming profile should include appropriate peer player/entity selection criteria and the game selection criteria as shown respectively by 1520 and 1540 in FIG. 15. The peer player selection criteria impose the requirements to be met by any prospective peer player that is interested in playing a given online multiplayer game in terms of sex, nationality, ethnicity, profession, age, mother tongue, religion, max-points/level achieved and the like—although some of these can be made optional at the discretion of a given user/player/entity. This list of criteria is non-exhaustive and hence may include new fields depending on future gaming trends, user preferences and needs. As it can be seen, the user can choose the appropriate answer/value/entry for every field of 1520 from different drop-down lists. In case any of the drop-down lists does not contain the appropriate value/entry, there exists a room for the user to enter it. The corresponding additions will be made by 140/160 and it will appear in future sub-profiles. If no value is chosen, the particular criterion will not be used in the automatic peer player selection. These requirements by a player A will be checked against the main profile entries of others who have one or more complete activated gaming sub-profiles in order to automatically select the appropriate peer players. Similarly, game specific selection criteria will be entered in 1540. Both in 1520 and 1540, users are able to specify any other user-specific or game specific criterion. Each user is then given a chance to create more than one gaming sub-profile depending on the preferences of varieties of games and to activate each of the sub-profiles as shown in 1500 of FIG. 15.

It is preferred that whenever a new game is released, its name has to be registered for the first time along with one or plurality of keywords in the central database 130 by any user where a unique number (in an increasing order) known as a Game ID will be assigned to each game appended to the game list. The server application 160 is involved in this new game registration by a user in order to check whether the new game to be registered is in deed new and is different from others that have already been registered with the database 130 and to assign a Game ID on a successful check. A different gaming database can be maintained by the server 140 for this purpose.

This game related information should be consistent and is needed for each player/entity to know as to what type of games a user/entity is able to play. Based on the main profile and online gaming sub-profile information, the service discovery protocol and 172 run by the server application 160 will proactively or reactively find out appropriate peer players. The description of the Service Discovery and Service Invocation protocols is out of scope of this patent and in the case of peer/service discovery any centralised service discovery protocol can be used.

Preferably, it is most appropriate for the service discovery protocol of user A, who is interested in a multiplayer online game, to identify one or more right peers who are available to play a given game longer.

An entity/user/player is also given a chance to include the profile addresses of other popular online portals/websites in 1560 to be included in the virtual business card—but again its visibility is subject to the owner's privacy settings as explained in connection with FIG. 3.

The same approach as taken for online game sub-profile creation/maintenance can be taken for other sub-profiles namely recruitment, classified ads and the like being used to enrich the iDirectory with entity-specific information.

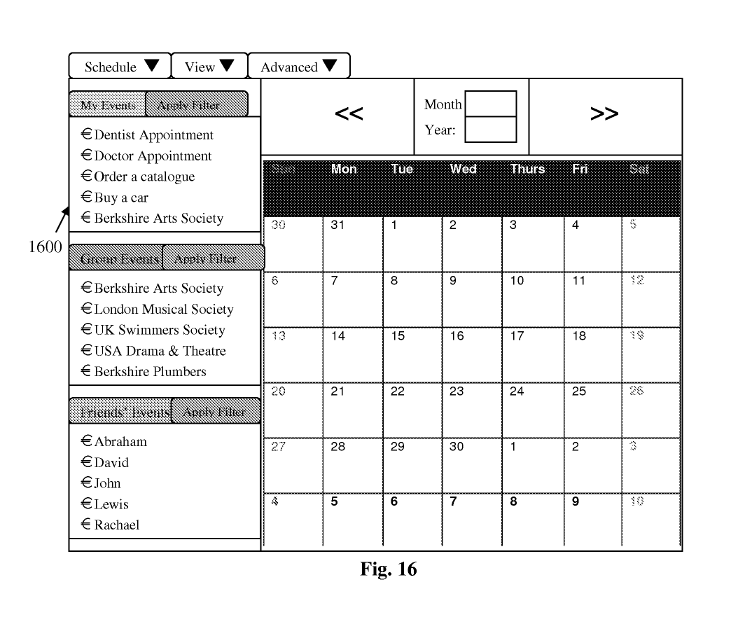

Another key feature of the iDirectory is the maintenance of online diary/calendar by any user, group or a business entity. Any online activity group/forum/business members of the iDirectory may be scattered all over the place possibly on different networks and platforms and can be in different time zones. This is the reality of modern virtual organisational structure of any business/social entity. With this online diary/calendar feature of the iDirectory, friends can see each others appointments, schedules and availability. This is true for members of any activity group/forum or for business partners depending on the privacy settings of the profile owners. With this web-based calendar/diary feature, employees of a business, members of a special activity group/forum or friends can schedule meetings, service calls, appointments and events online in a very collective way. An exemplified calendar/diary is shown in 1600 of FIG. 16. Further, this feature will allow anybody to access his/her schedule and events in an anytime and anywhere manner. When scheduling meetings, email invitations can be distributed to intended participants and hence, it is possible to get a yes or no answer immediately. It also has an added feature to send email remainders to participants of the meetings periodically.

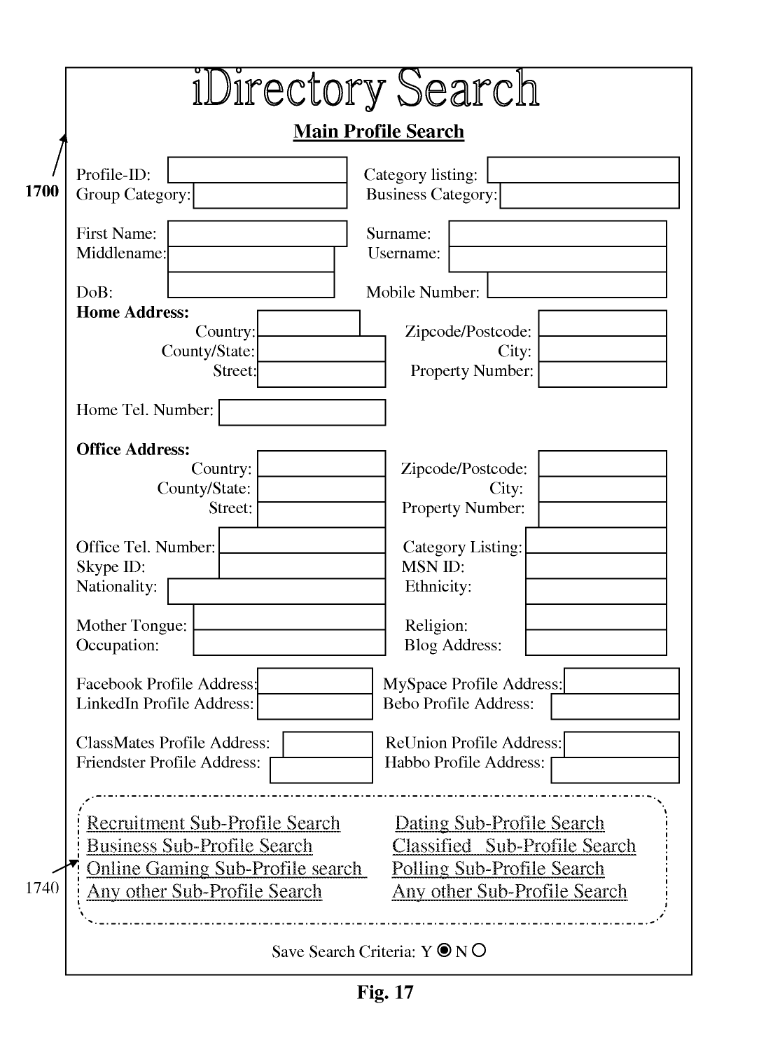

It is also possible to list the profiles belonging to individual users/entities of the iDirectory based on a specific geographic area, gender, age, religion, ethnicity, mother tongue, occupation or a combination of any of these. Profiles of businesses can be listed based namely on business category, industry, product/service, country, and the like or a combination of any of these, whereas the profile listing of groups can be possible based on geographic area, gender, age groups, religion, ethnicity, mother tongue, occupation, group category or a combination of any of these. An exemplified search/filtering window is shown by 1700 of FIG. 17.

As it can be seen in 1700, various sub-profile searches are possible by clicking the hyperlink associated with different sub-profiles encapsulated within 1740.

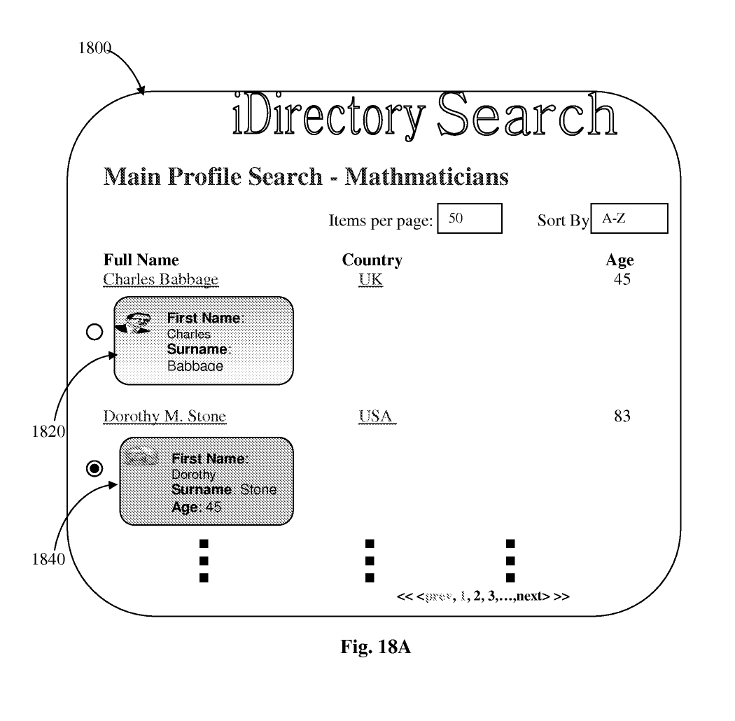

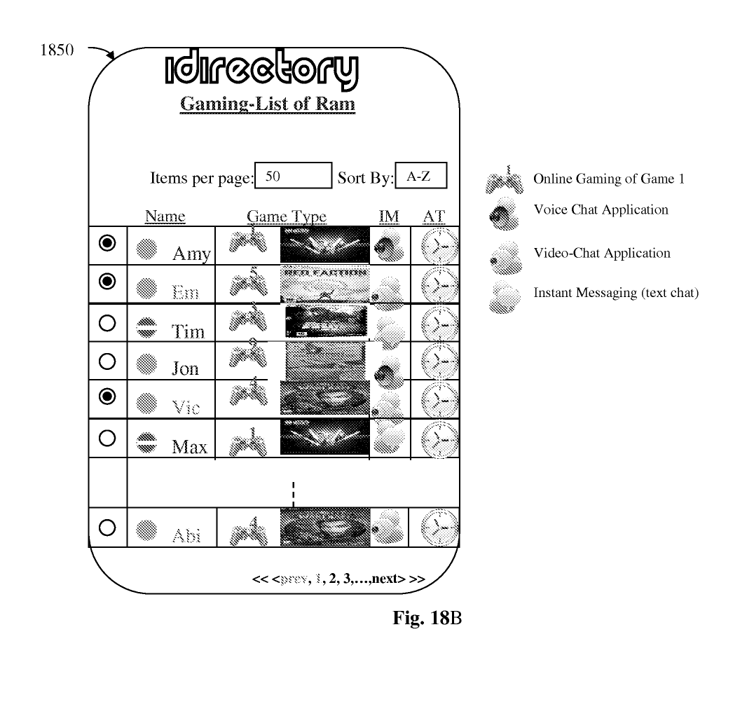

FIG. 18A illustrates one exemplary resulting list view of the main profile search using the occupation as the sole filtering/search criterion according to an embodiment of the present invention. Anonymous interaction/communication is possible provided the owners of the entries listed in 1800 allow it.

Suppose a first registered entity X met a long time friend or a stranger Y on the road and all what the first entity X knows about Y is the latter's vehicle registration number. Entity X can use iDirectory service and perform a profile search based on what X knows. Suppose Y has included his/her vehicle registration number at the time of main profile creation. If Y's privacy settings allow, X is allowed to see the virtual business card belonging to Y similar to the one shown by 1250 with limited/much content. With this, a registered entity X can initiate an anonymous interaction/communication with a registered entity Y via one or plurality of suitable communication modes/mediums/mechanisms being allowed as stipulated by the privacy settings of Y. Similarly, a search can be performed on the iDirectory service based on any search criterion and the result would enable any two strangers to have anonymous interaction/communication using the communication mode/medium/mechanism being allowed by the privacy settings of the callee.

FIG. 18B illustrates one exemplary resulting list view 1850 of the online gaming service that can allow any player that has conducted such a search to initiate the preferred online game with one of the entries/entities listed on 1850. As shown in 1850, the online garners who are available to play one or more of the registered games as set out in a gaming sub-profile are shown together with their respective usernames, games identities in terms of a unique number assigned by the server application 160 each time a new game is registered for the first time, availability time (AT), different varieties of multimedia instant messaging (IM) facilities being available. The availability time (AT) can be specified by each player at any time instance that can indicate how long a given player is available to play any online game or a given online game. It lists down both the “online” and “busy” players with a facility to choose one or more. In 1850, for instance, the game icon is accompanied by a specific Game ID which is assigned by the server application 160 at the time of it being registered for the first time—this can be saved in a database called gaming database. This Game ID is used to index this gaming database and also hence can be used to uniquely identify a given game by the user, service discovery protocol and the corresponding gaming database, if any.

Security is the biggest concern when it comes to spontaneous collaboration among total strangers and the online iDirectory services aim to tackle this by getting the central server 140 and 160 to take an additional function of a common Public Key Infrastructure (PKI)—the corresponding functionality of 160 is identified by 170. For this purpose, the iDirectory server 140 can maintain either a separate database or enrich the profile database 130 with additional PKI/AAA related information. This patent, however, does not aim to propose any novel authentication or encryption mechanisms. Instead, it uses public key cryptography for two-way (or mutual) authentication purposes in a novel way in order to facilitate safe spontaneous collaboration, interactions and socialising. With this arrangement secure spontaneous collaboration among strangers is possible for the first time in the case of online social networking process. Please note that public key cryptography is used for the purpose of (mutual) authentication only by peer entities or the server application 160 as part of any session setup.

Two-way or mutual authentication and non-repudiation are important, because these allow two strangers to communicate privately but securely in a peer-to-peer manner in the envisioned social networks. Accordingly, whenever a user registers with the iDirectory server 170 for the first time, he/she will be assigned asymmetric keys along with a Profile-ID. These two keys can be stored in the profile database 180 or in a separate database. With this arrangement, an originator/sender of a packet (e.g., a friend request and the like) needs to sign with his/her private key. Preferably, the originator's/sender's packet should contain Profile-IDs of both the sender and the recipient(s) in the packets and it is routed to the possible recipient based on the Profile-ID of the latter. The received packet can be verified by anyone who has access to the sender's public key, thereby proving that the sender had access to the private key (and therefore is likely to be the person associated with the public key used), and the part of the message that has not been tampered with. The Profile-ID of a user/device can be used as an index to find the corresponding Public key of a particular user. This way mutual or two-way authentication is performed by spontaneously collaborating users.

Another added feature of this iDirectory is the possibility for the service/peer discovery protocol to avoid problematic peers/devices/users based on the community trust building process being possible here. Accordingly, malicious behaviours of devices/peers/users can be identified and reported to the central profile database 130, and this will help spontaneous collaborators to avoid problem creating Profile-IDs. The functionality of the server application 160 is augmented to handle this community-based trust building wherein with an inclusion of one more field in every user's profile record being kept in the profile database 130, the server application 160 can record the number of complaints it has received for a given Profile-ID and consider this in the service/peer discovery process.

1. There is provided a system for the purpose of creating/maintaining online directory containing one or plurality of virtual business cards pertaining to different entities (individual, group or business) for the purpose of enabling anonymous interaction/communication between two or more total strangers; wherein the system comprising:
i) a profile database to hold a plurality of virtual business cards and associated information pertaining to an entity;
ii) an online profile creation mechanism;
iii) a centralised server connected to the said profile database for operating the said profile database and running a server application;
iv) one or plurality of entities—each using a client computing devices running a client application each; and,
v) an availability of ubiquitous communication and computing network enabling the connectivity between said client application running on any client device and the said server application running on the said centralised server;
Wherein each first entity is responsible for the creation/maintenance of a virtual business card containing the name and the plethora of its contact details pertaining to a variety of communication modes/media/mechanisms using the said online profile creation mechanism, and the said system allows each first entity to exercise a minute privacy settings in terms of who can see what information of its virtual business card; wherein the said system further allows a second entity that is total stranger to the first entity to anonymously initiate and engage in a secure interaction/communication in a seamless way via one or plurality of communication modes/media/mechanisms with the first entity when the exact contact details of the chosen communication mode/medium/mechanism are not visible to a second entity.

2. The said system for the purpose of creating/maintaining online directory containing one or plurality of virtual business cards pertaining to different entities for the purpose of enabling anonymous interaction/communication between two or more total strangers securely and seamlessly according to claim 1; wherein the said communication mode/medium/mechanism can be PSTN/PLMN/ISDN or satellite line supporting voice/video communication, Internet supporting Instant Messaging and Presence Service (IMPS), SNS, VoIP/V2IP and the like, email, regular postal mail, or the like.

3. The said system for the purpose of creating/maintaining online directory containing one or plurality of virtual business cards pertaining to different entities for the purpose of enabling anonymous interaction/communication between two or more total strangers securely and seamlessly according to claim 1; wherein the said server application supports one or plurality of services related namely to online profile maintenance, anonymous interaction/communication, virtual business card exchange and viewing, service repository, AAA, service/peer discovery and the like.

4. The said system for the purpose of creating/maintaining online directory containing one or plurality of virtual business cards pertaining to different entities for the purpose of enabling anonymous interaction/communication between two or more total strangers securely and seamlessly according to claim 1; wherein the said online profile creation mechanism comprising the steps of:
a) enabling the first entity to create/activate/edit/maintain/delete a mandatory main profile expecting entity-specific important (e.g., personal) details for the server to uniquely identify/verify/bind the entity concerned and a social sub-profile containing plethora of contact details pertaining to a varieties of communication/interaction mode/media/mechanisms;
b) getting the said client application running on the first client device to make connection and to register the created main profile and the social sub-profile with the said profile database by liaising with the server application via the said ubiquitous communication and computing network;
c) on receiving the main profile and the associated activation, the said server application assigning a unique profile identifier to each entity and storing the profile information in the said profile database and indexing the entry using the said profile identifier;
d) getting each entity to configure the said local client application with the entity-specific login IDs pertaining to preferred communication/interaction modes/media/mechanisms namely SNS/IMPS/VoIP/V2IP services (e.g., Skype, MSN messenger, Google Talk, ICQ, Twitter, Yahoo, MySpace, Facebook and the like) included in the said social sub-profile when prompted and the said client application of each entity keeping records of the profile addresses along with the given entity's login IDs pertaining to the user accounts of the said preferred communication/interaction modes/media/mechanisms locally at the time of profile creation; and,
e) the said server application automatically creating and storing user accounts pertaining to different communication/interaction modes/media/mechanisms namely SNS/IMPS/VoIP/V2IP services (e.g., Skype, MSN messenger, Google Talk, ICQ, Twitter, Yahoo, MySpace, Facebook and the like) depending on a given entity's preferred SNSs where those user accounts correspond to the every first entity, passing those details on to the given entity's client application and requesting the given entity to associate those automatically created user accounts with its own corresponding user accounts; and,
f) the said server application monitoring further sub-profile creation by first entity and storing the details on reception of any additional sub-profile in the said profile database;
wherein once created, the said server application can receive requests consisting of a plurality of search criteria to view the social profile of the first registered entity by a second entity using a second client device; and the unique profile identifier is used by the said client or server application to uniquely bind and identify each entity.

5. The said system for the purpose of creating/maintaining online directory containing one or plurality of virtual business cards pertaining to different entities for the purpose of enabling anonymous interaction/communication between two or more total strangers securely and seamlessly according to claim 1; wherein each virtual business card contains the name and almost all contact details and the said system allows the owner to exercise a minute privacy settings in terms of who can see what information of the virtual business card based on demography, geography, political views, gender, occupation, age range and the like and such privacy settings are possible prior to, at the time of or after a virtual business card exchange.

6. The said system for the purpose of creating/maintaining online directory containing one or plurality of virtual business cards pertaining to different entities for the purpose of enabling anonymous interaction/communication between two or more total strangers securely and seamlessly according to claim 1; wherein the said system allows anonymously interaction/communication between two or more entities that are total strangers to each other only when those entities involved already maintains active profiles in the said centralised directory.

7. The said system for the purpose of creating/maintaining online directory containing one or plurality of virtual business cards pertaining to different entities for the purpose of enabling anonymous interaction/communication between two or more total strangers securely and seamlessly according to claim 1; wherein the said system allows the owner to exercise a minute privacy settings in terms of who can anonymously interact/communicate using what communication/interaction modes/media/mechanisms based on demography, geography, political views, gender, occupation, age range and the like and such privacy settings are possible prior to, at the time of or after a virtual business card exchange.

8. The said system for the purpose of creating/maintaining online directory containing one or plurality of virtual business cards pertaining to different entities for the purpose of enabling anonymous interaction/communication between two or more total strangers securely and seamlessly according to claim 1; wherein when a first entity viewing the virtual business card of a second registered entity and when the exact contact details pertaining to the preferred communication mode/media/mechanisms are invisible due to the privacy settings of the second registered entity, and whenever a first entity initiates an anonymous communication/interaction via the preferred mode/media/mechanism by clicking it, the system running an authentication/security procedure prior to setting up any anonymous interaction/communication between two strangers that comprising the steps of:
i) the said server application constantly monitoring for any anonymous interaction/communication request originating from any client application of a registered entity;
ii) the client application of a first entity informing a first entity's intent to the said server application;
iii) on receiving the request, the server application subject a first entity to an authentication process;
iv) on being successfully authenticated, the said server application ascertaining the interaction/communication mode/medium/mechanism chosen by a first entity for the anonymous interaction/communication (e.g., telephone, Skype, IM, and the like) and checking the privacy settings of the second entity for the chosen interaction/communication mode/medium/mechanism;
v) the said server application proceeding to the next stage only if the anonymous interaction/communication via the chosen mode/medium/mechanism is allowed by the second entity as stipulated in its privacy settings; otherwise the server application terminating the anonymous communication attempt by a first entity and notifying it with appropriate error message;
vi) if, on the other hand, the privacy settings of the second entity allow the said anonymous interaction/communication by a first entity via the chosen communication mode/medium/mechanism, the server application making further decisions based on the chosen communication mode/medium/mechanism;
vii) in case the chosen communication mode/medium/mechanism is/uses PSTN/PLMN/ISDN, the server application running the circuit-switched procedure;
viii) if, on the other hand, the chosen communication mode/medium/mechanism is/uses Internet, the server application running Internet procedure;
ix) if, on the other hand, the chosen communication mode/medium/mechanism is/uses electronic mailing/messaging, the server application running email procedure;
x) if, on the other hand, the chosen communication mode/medium/mechanism is/uses regular postal mail, the server application running snail mail procedure;
Wherein registered entities are identified by their respective unique profile identifiers by the said system and for such a seamless and anonymous communication/interaction to take place the second entity has to be registered and maintains an active profile with the said system and the privacy settings of the second entity should allow such an anonymous communication/interaction from a stranger.

9. The said system for the purpose of creating/maintaining online directory containing one or plurality of virtual business cards pertaining to different entities for the purpose of enabling anonymous interaction/communication between two or more total strangers securely and seamlessly according to claim 8; wherein in case the chosen communication mode/medium/mechanism for the anonymous interaction/communication initiated by a first registered entity towards a second registered entity uses PSTN/PLMN/ISDN, the server application running the circuit-switched procedure comprising the steps of:
i) the said server application checking from the said profile database whether a first registered entity has enough calling credit/privilege;
ii) if a first registered entity does not have enough calling credit/privilege, the said server application will request it to top up its calling credit before it can proceed further; otherwise the said server application will terminate the said circuit-switched procedure;
iii) If, on the other hand; a first registered entity has enough calling credit/privilege, the said server application will try to get the PSTN/PLMN/ISDN number of second registered entity with which a first entity tries to interact/communicate anonymously from its profile information being stored in the said profile database;
iv) in case a second registered entity does not include its PSTN/PLMN/ISDN number in its profile, the said server application will send a corresponding error message to a first entity and terminate the said circuit-switched procedure;
v) if, on the other hand, the said server application has obtained the PSTN/PLMN/ISDN number of second registered entity, the said server application establishing the communication (e.g., Voice/Video, SMS/MMS or FAX) channel (Segment 1) with a first registered entity via the Internet;
vi) the said server application will then proceed to establishing the communication (e.g., Voice/Video, SMS/MMS or FAX) channel (Segment 2) with a second registered entity via the PSTN/PLMN/ISDN network;
vii) the said server application will subsequently link/map Segment 1 and Segment 2;
viii) if the linking/mapping is successful, the said server application will start transporting user traffic back and forth between both Segments 1 & 2 and monitoring the progress of the communication/interaction session; on the other hand, if the linking is unsuccessful, the said server application will tear down the Segments 1 & 2, generate a corresponding error message and notify the parties involved;
ix) in case the anonymous communication/interaction session is terminated, the said server application will tear down Segments 1 and 2, terminate the anonymous session and charge a first registered entity based on usage/time (i.e., time duration of the whole session or type/amount of traffic generated as part of the anonymous interaction/communication).

10. The said system for the purpose of creating/maintaining online directory containing one or plurality of virtual business cards pertaining to different entities for the purpose of enabling anonymous interaction/communication between two or more total strangers securely and seamlessly according to claim 8; wherein in case the chosen communication mode/medium/mechanism for the anonymous interaction/communication initiated by a first registered entity towards a second registered entity uses the Internet, the server application running the Internet procedure comprising the steps of:
i) the said server application checking whether a first registered entity has already associated the automatically created user account with its own corresponding user accounts pertaining to the communication/interaction mode/medium/mechanism (e.g., VoIP/V2IP/IM/SNS such as Skype, MSN messenger, Google Talk, ICQ, Twitter, Yahoo, MySpace, Facebook (typical example of a SNS-based anonymous communication is to post on the wall) and the like) chosen for the anonymous interaction/communication;
ii) if not associated already, the said server application requesting a first registered entity to associate the user accounts;
iii) if, on the other hand, user accounts of first registered entity being already associated, the said server application will further check whether a second registered entity has already associated the automatically created user account with its own corresponding user accounts pertaining to the communication/interaction mode/medium/mechanism chosen by first registered entity for the anonymous interaction/communication;
iv) if not, the said server application will generate a corresponding error message, notify first registered entity about it and terminate the said Internet procedure;
v) if, on the other hand, second registered entity has already associated the server created account with its own account, the said server application will check whether the anonymous interaction/communication requires the parties involved to be online;
vi) if it is an online interactive session, the said server application will check the online status of second registered entity corresponding to the anonymous interaction/communication mode/medium/mechanism (e.g, VoIP/V2IP/IM/SNS and the like) chosen;
vii) if a second entity is online, the said server application proceeding to the next stage; otherwise it will generate a corresponding error message, notify a first registered entity about it and terminate the said Internet procedure;
viii) if being online, the said server application establishing a communication channel between a second registered entity and the server created profile corresponding to a second registered entity (Segment 1) using the VoIP/V2IP/IM/SNS service used;
ix) the said server application further establishing a communication channel between a first registered entity and the server created profile corresponding to a first registered entity (Segment 2) using the VoIP/V2IP/IM/SNS service used;
x) the said server application will subsequently link/map Segment 1 and Segment 2;
xi) if the linking/mapping is successful, the said server application will start transporting user traffic back and forth between both Segments 1 & 2 and monitoring the progress of the communication/interaction session; on the other hand, if the linking is unsuccessful, the said server application will tear down Segments 1 & 2, generate a corresponding error message and notify the parties involved;
ix) in case the anonymous communication/interaction session is terminated, the said server application will tear down Segments 1 and 2 and terminate the anonymous session.

11. The said system for the purpose of creating/maintaining online directory containing one or plurality of virtual business cards pertaining to different entities for the purpose of enabling anonymous interaction/communication between two or more total strangers securely and seamlessly according to claim 8; wherein in case the chosen communication mode/medium/mechanism for the anonymous interaction/communication initiated by a first registered entity towards a second registered entity is/uses electronic messaging/mailing, the server application running the email procedure comprising the steps of:
i) the said server application trying to get the email address of second registered entity from its profile being stored in the said profile database;
ii) in case a second registered entity does not include its email address in its profile, the said server application will send a corresponding error message to a first entity and terminate the said email procedure;
iii) if, on the other hand, the said server application has obtained the email address of second registered entity, the said server application reading the email from a first registered entity, creating clone of it while replacing the recipient's address with that of a second registered entity;
iv) the said server application sending the email to a second registered entity and notifying a first registered entity about it.

12. The said system for the purpose of creating/maintaining online directory containing one or plurality of virtual business cards pertaining to different entities for the purpose of enabling anonymous interaction/communication between two or more total strangers securely and seamlessly according to claim 8; wherein in case the chosen communication mode/medium/mechanism for the anonymous interaction/communication initiated by a first registered entity towards a second registered entity is/uses regular postal mail, the server application running the snail mail procedure comprising the steps of:
i) the said server application trying to get the regular postal address of second registered entity from its profile being stored in the said profile database;
ii) in case a second registered entity does not include its regular postal address in its profile, the said server application will send a corresponding error message to a first entity and terminate the said snail mail procedure;
iii) if, on the other hand, the said server application has obtained the regular postal address of second registered entity, the said server application reading the electronic message received from a first registered entity, creating a letter addressing to a second registered entity, taking a print out of the created letter and printing an envelope with the postal address of a second registered entity;
iv) the said server application requesting human personnel attached to the said system to post the created letter.

13. The said system for the purpose of creating/maintaining online directory containing one or plurality of virtual business cards pertaining to different entities for the purpose of enabling anonymous interaction/communication between two or more total strangers securely and seamlessly according to claim 1; wherein each virtual business card contains one or plurality of the following contact details:
i) name, and addresses, telephone numbers, mobile numbers, email addresses and web sites pertaining to home/office;
ii) profile addresses of one or plurality of SNSs (e.g., Facebook, LinkedIn, Twitter, MySpace, Hi5, and the like);
iii) profile addresses of one or plurality of Instant Messaging and Presence Service (IMPS) such as MSN messenger, Google Talk, ICQ and the like;
iv) VoIP/V2IP services (e.g., Skype);
v) profile addresses of one or plurality of photo-/audio-/video-sharing web-sites such as Picasa, Flickr and the like;
vi) profile addresses of one or plurality of dating, recruitment, classified advertisement, recruitment, business, online multiplayer gaming, online polling, online diary/schedule/calendar and the like;
wherein an exchange of virtual business cards between two registered entities can take place via the said client computing devices in a peer-to-peer manner and the owner of a business card has the flexibility to include/exclude any number of contact details at his/her discretion depending on the type of recipient and to exercise a minute control over who can see what type of contact details very dynamically.

14. The said system for the purpose of creating/maintaining online directory containing one or plurality of virtual business cards pertaining to different entities for the purpose of enabling anonymous interaction/communication between two or more total strangers securely and seamlessly according to claim 1; wherein an exchange of virtual business cards between a first registered entity and a second entity can take place via the said client computing devices in a peer-to-peer manner and for this purpose the said client application has be first installed in a client computing device that in turn runs a virtual business card exchange procedure comprising the steps of:
a) the said client application of first registered entity checking whether an entity/user has signed in to the said client application;
b) in case a entity has not signed in already, the said client application will prompt the first registered entity to sign in or log on;
c) once a first registered entity has signed in, the client application of first entity constantly capturing the intention of the concerned entity to exchange the virtual business card from any user input;
d) if there is an intention, the said client application of first entity will check whether the entity would like to perform any privacy setting before the exchange; if yes, client application will prompt a first entity to perform the tailor-made privacy settings at its discretion;
e) once the privacy settings are performed, the client application will perform the necessary handshake before the actual exchange (e.g., authentication can be performed in the initial exchange);
f) in case the client application of first registered entity determines that a second entity is not registered or signed in, the client application of first registered entity will request a second entity to sign in or log on if a second entity is registered already or otherwise invite a second entity to first register and sign in or log on;
g) after an initial handshake, the respective client applications of first and second entities will passing the said unique profile identifiers pertaining to each entity on to the other; and,
h) each respective client application using the received unique profile identifier to fetch the full virtual business card details from the said profile database.
i) in case post-exchange privacy settings are preferred the respective client application will prompt an entity to populate its list of entities (termed buddy-list) with which it has successfully exchanged the virtual business card and to perform the necessary privacy settings against a given entry/entity of the said list (i.e., buddy-list).

15. The said system for the purpose of creating/maintaining online directory containing one or plurality of virtual business cards pertaining to different entities for the purpose of enabling anonymous interaction/communication between two or more total strangers securely and seamlessly according to claim 1; wherein when the exact contact details of a first entity is not visible to a second entity due to the privacy settings of the first entity, necessary icons of each communication mode/medium/mechanism will be displayed for the second entity to know the different variety of communication modes that can be employed to engage in a seamless and anonymous communication/interaction with the first entity.

16. There is provided a method for an entity to create an online directory that is enriched with entity-specific data to function as a service repository, wherein with an aid of client application running in the entity's client device, each entity connects to the centralised server application running on a centralised server that maintains a profile database containing a user-specific profile data, with an objective to create and maintain a user-specific virtual business card mainly consisting of each user's profile names/IDs/addresses of one or plurality of other social networking sites such as Facebook, Skype, MSN, Hi5 and the like, personal/business information, business/personal video/audio clips and other contact details in addition to user's personal information namely first/middle/last name and the date-of-birth, and other services and products each user provides/sells/advertises or interested in and the said server application executes a directory management procedure for entities to maintain/view the online directory services and the said procedure comprising the steps of:
1) starting a timer;
2) checking to see whether any first entity attempts to create a profile with the use of the said client application that runs locally in the client device being used by the first entity, and when the first entity activates a new profile for the first time, generating and assigning a unique profile identifier to every successfully registered entity, storing the created profile in the said centralised profile database and getting the entity to configure the client application with the login IDs of the multitude of other SNSs the entity has profile addresses already while employing any known mutual authentication mechanism;
3) in response to a profile creation, the said server application creating automatically user accounts/profiles pertaining to different SNSs such as Skype, MSN messenger, Google Talk, ICQ, Twitter, Yahoo, MySpace, Facebook and the like depending on a given entity's preferred SNSs, passing those details on to the given entity's client application and requesting the given entity to associate those automatically created user accounts with its own user accounts;
4) Checking to see whether a search request is received from the client application of the second registered entity, and when it happens, running a centralised service/peer discovery protocol, performing profile matching and informing the outcome to the second entity;
5) When a second registered entity intends to have an anonymous communication/interaction with the first entity using a preferred SNS/IM/VoIP/V2IP or PLMN/ISDN service, where both the first user and the second registered user do not see each other's contact details of any sort, after a mutual authentication, liaising with the client application and mapping the profile identifiers of the entities with login-IDs of the chosen SNS/IM/VoIP/V2IP service or the telephone numbers of the PLMN and initiating an anonymous communication/interaction seamlessly using overlaying principles;
6) Whenever a timeout occurs, running a centralised service/peer discovery protocol, performing profile matching and informing the outcome to every interested entity;
7) whenever the mutual authentication fails at any stage, preventing an entity from collaborating;
Wherein the said directory management procedure executed by said server application is both time-driven and event-driven.

17. The said method for an entity to create an online directory according to claim 16; wherein exchange of virtual business cards between two entities can take place via the said client computing devices and such a virtual business card exchange comprising the steps of:
a) passing the said unique profile identifiers pertaining to each entity on to the other in a peer-to-peer manner; and,
b) using the received unique profile identifier to fetch the full virtual business card details from the said online directory.
Wherein the said online directory is indexed by the said unique profile identifiers and said method allows the owner of a business card to have the flexibility in terms of number of contact details the owner can include/exclude at his/her discretion depending on the type of recipient and to exercise a minute control over who can see what type of contact details very dynamically.

18. The said method for an entity to create an online directory according to claim 16; wherein the first entity creates the main mandatory profile and advertises any product the first entity wants to sell, share, provide or the services the first entity provides using the first client device through the creation and maintenance of one or more pre-defined sub-profiles and any second registered entity inquires the said service repository using a second client device while specifying the user-based selection criteria for the products/services the second registered entity is interested in and subsequently the second registered entity will be informed of the most appropriate product/service providers satisfying the second registered entity's selection/filter criteria; wherein this type of inquiry by the second entity will trigger anonymous interaction/communication among entities.

19. The said method for an entity to create an online directory according to claim 16; wherein the said online directory enables online dating wherein its said service repository functionality keeping one or more up-to-date dating sub-profiles of each interested entity, and gets the said server application to run a centralised service discovery protocol to automatically/manually help each entity find one or more appropriate matched profiles while meeting the selection/filter criteria as set out in the dating sub-profiles of each entity, wherein the said centralised service discovery protocol will enable anonymous interaction/communication among entities.
